(19) United States
(12) Patent Application Publication
(10) Pub. No.: US 2016/0262073 A1
(43) Pub. Date: Sep. 8, 2016

(54) SYSTEM AND METHOD FOR PROVIDING MAXIMUM FILL LINK VIA BONDED SERVICES

(71) Applicants: Praveen Vasant Muley, Cupertino, CA (US); Laurent Thiebaut, Antony (FR); Wim Henderickx, Westerlo (BE); Francois L. Bouchard, San Jose, CA (US); Vachaspathi P. Kompella, Cupertino, CA (US); Kiran Kumar Reddy Mundla, Santa Clara, CA (US); Sudeep Shrikrishna Patwardhan, Fremont, CA (US); Harinath Rachapalli, WoodRidge, IL (US); Hugh Roche, Naperville, IL (US)

(72) Inventors: Praveen Vasant Muley, Cupertino, CA (US); Laurent Thiebaut, Antony (FR); Wim Henderickx, Westerlo (BE); Francois L. Bouchard, San Jose, CA (US); Vachaspathi P. Kompella, Cupertino, CA (US); Kiran Kumar Reddy Mundla, Santa Clara, CA (US); Sudeep Shrikrishna Patwardhan, Fremont, CA (US); Harinath Rachapalli, WoodRidge, IL (US); Hugh Roche, Naperville, IL (US)

(73) Assignees: Alcatel-Lucent USA Inc., Murray Hill, NJ (US); Alcatel-Lucent Bell N.V., Antwerp (BE); Alcatel Lucent, Boulogne-Billancourt (FR)

(21) Appl. No.: 15/047,821

(22) Filed: Feb. 19, 2016

Related U.S. Application Data
(60) Provisional application No. 62/128,346, filed on Mar. 4, 2015.

(51) Int. Cl. H04W 36/22; H04M 15/00; H04L 29/12; H04L 12/26; H04L 12/743

(52) U.S. Cl. CPC H04W 36/22; H04L 43/0876; H04L 43/16; H04L 45/7453; H04L 61/2007; H04M 15/66

(57) ABSTRACT

The disclosure relates generally to supporting a maximum fill link capability for a bonded session. The maximum fill link capability may be configured to control allocation of user device traffic of a user device across multiple bearers of a bonded data plane session supported for the user device. The maximum fill link capability may be provided at a gateway device associated with the bonded data plane session, which may be a network gateway device for downstream user device traffic or a customer gateway device for upstream user device traffic. The maximum fill link capability may be configured to determine an allocation of the user device traffic of a user device data plane session to multiple bearers of the user device data plane session based on policy information associated with the user device data plane session and based on traffic monitoring performed for the user device traffic of the user device data plane session.

### CROSS REFERENCE TO RELATED APPLICATION

This application claims the benefit of pending U.S. Provisional Patent Application Ser. No. 62/128,346, filed on Mar. 4, 2015, entitled “SYSTEM AND METHOD PROVIDING MAXIMUM FILL LINK VIA BONDED SERVICES,” which is hereby incorporated herein by reference in its entirety.

### TECHNICAL FIELD

The disclosure relates generally to communication networks and, more specifically but not exclusively, to use of bonded services in communication networks.

### BACKGROUND

Various types of devices may be capable of communicating via multiple access technologies. For example, various types of end user devices (e.g., smartphones, tablet computers, or the like) are typically capable of communicating via multiple access technologies, such as via various cellular wireless access networks (e.g., Third Generation (3G), Long Term Evolution (LTE), or the like) as well as via various local wireless access networks (e.g., WiFi networks such as 802.11x networks or the like). Similarly, for example, various types of Customer Premises Equipment (CPE) (e.g., Residential Gateways (RGs), set-top boxes (STBs), routers, switches, or other types of residential/enterprise gateway devices) may be capable of communicating via multiple access technologies, such as via wireless access technologies (e.g., cellular wireless access technologies such as 3G or LTE, local wireless access technologies such as Wi-Fi, or the like) as well as via various wireline access technologies (e.g., Digital Subscriber Line (DSL) access, cable access, optical network access, or the like).

### SUMMARY

Various deficiencies in the prior art are addressed by embodiments for using a bonded service within a communication network.

In at least some embodiments, an apparatus includes a processor and a memory communicatively connected to the processor, wherein the processor is configured to receive, at a gateway device configured to support a user device data plane session having multiple bearers associated with multiple different access networks, user device traffic of the user device data plane session, perform traffic monitoring for the user device traffic of the user device data plane session, and determine, based on policy information associated with the user device data plane session and based on the traffic monitoring for the user device traffic of the user device data plane session, an allocation of the user device traffic of the user device data plane session to the multiple bearers of the user device data plane session.

In at least some embodiments, a non-transitory computer-readable storage medium stores instructions which, when executed by a computer, cause the computer to perform a method, the method including receiving, at a gateway device configured to support a user device data plane session having multiple bearers associated with multiple different access networks, user device traffic of the user device data plane session, performing traffic monitoring for the user device traffic of the user device data plane session, and determining, based on policy information associated with the user device data plane session and based on the traffic monitoring for the user device traffic of the user device data plane session, an allocation of the user device traffic of the user device data plane session to the multiple bearers of the user device data plane session.

In at least some embodiments, a method includes receiving, at a gateway device configured to support a user device data plane session having multiple bearers associated with multiple different access networks, user device traffic of the user device data plane session, performing traffic monitoring for the user device traffic of the user device data plane session, and determining, based on policy information associated with the user device data plane session and based on the traffic monitoring for the user device traffic of the user device data plane session, an allocation of the user device traffic of the user device data plane session to the multiple bearers of the user device data plane session.

In at least some embodiments, an apparatus includes a processor and a memory communicatively connected to the processor, wherein the processor is configured to receive, at a gateway device configured to support a user device data plane session having multiple bearers associated with multiple different access networks, user device traffic of the user device data plane session, wherein the multiple bearers comprise a first bearer and a second bearer, the second bearer having a wireless user device associated therewith, propagate the user device traffic of the user device data plane session via the first bearer, perform traffic monitoring for the user device traffic of the user device data plane session, and, based on a determination to switch at least a portion of the user device traffic of the user device data plane session from the first bearer to the second bearer, initiate a process for paging the wireless user device.

In at least some embodiments, a non-transitory computer-readable storage medium stores instructions which, when executed by a computer, cause the computer to perform a method, the method including receiving, at a gateway device configured to support a user device data plane session having multiple bearers associated with multiple different access networks, user device traffic of the user device data plane session wherein the multiple bearers comprise a first bearer and a second bearer and wherein the second bearer has a wireless user device associated therewith, propagating the user device traffic of the user device data plane session via the first bearer, performing traffic monitoring for the user device traffic of the user device data plane session, and, based on a determination to switch at least a portion of the user device traffic of the user device data plane session from the first bearer to the second bearer, initiating a process for paging the wireless user device.

In at least some embodiments, a method includes receiving, at a gateway device configured to support a user device data plane session having multiple bearers associated with multiple different access networks, user device traffic of the user device data plane session wherein the multiple bearers comprise a first bearer and a second bearer and wherein the second bearer has a wireless user device associated therewith, propagating the user device traffic of the user device data plane session via the first bearer, performing traffic monitoring for the user device traffic of the user device data plane session, and, based on a determination to switch at least a portion of the user device traffic of the user device data plane session from the first bearer to the second bearer, initiating a process for paging the wireless user device.

### BRIEF DESCRIPTION OF THE DRAWINGS

The teachings herein can be readily understood by considering the detailed description in conjunction with the accompanying drawings, in which:

FIG. 1 depicts a high-level block diagram of a system benefiting from various embodiments;

FIG. 2 depicts a high-level block diagram of a system similar to the system of FIG. 1, while also further depicting various exemplary address indicators for various embodiments that avoid problems associated with end user device interaction;

FIG. 3 depicts a high-level block diagram of a system similar to the system of FIG. 2, while also further depicting an additional access network and related bearer path;

FIGS. 4A and 4B depict an exemplary embodiment of a method suitable for use within the systems of FIGS. 1-3;

FIG. 5 depicts an exemplary embodiment of a method suitable for use within the systems of FIGS. 1-3;

FIG. 6 depicts a graphical representation of a data plane model useful in understanding various embodiments;

FIG. 7 depicts a high-level block diagram of a similar to the system of FIG. 3, while also further depicting an additional end user device;

FIG. 8 depicts a high-level block diagram of a gateway device configured to support a maximum fill link capability;

FIG. 9 depicts an exemplary embodiment of a method for providing a maximum fill link capability at a gateway device;

FIG. 10 depicts an exemplary embodiment of a method for paging a wireless user device within the context of providing a maximum fill link capability at a gateway device; and

FIG. 11 depicts a high-level block diagram of a computer suitable for use in performing functions presented herein.

To facilitate understanding, identical reference numerals have been used, where possible, to designate identical elements common to the figures.

### DETAILED DESCRIPTION

Various embodiments are primarily described within the context of a mechanism for policy-based steering of data toward user equipment (UE) capable of receiving data via multiple paths (single-homed or multi-homed), wherein data associated with multiple service data flows (SDFs) or application flows (AFs) for a UE are allocated across multiple paths by a gateway device in accordance with policy information provided to the gateway device.

Various embodiments contemplate a policy-based downstream traffic steering mechanism operable at a gateway device, such as a Service Gateway (SGW), a Packet Gateway (PGW), or other provider equipment (PE).

Various embodiments contemplate a policy-based upstream traffic steering mechanism operable at a gateway device, such as a home or enterprise gateway device terminating paths associated with multiple different access technologies.

Various embodiments provide a mechanism for identifying and binding together multiple data bearing paths through various access technologies (e.g., Digital Subscriber Line (DSL), cable, Wi-Fi, Long Term Evolution (LTE), Third Generation (3G) wireless networks, or the like) between a PGW and Customer Premises Equipment (CPE) to form thereby a bonded service combining multiple bearers (e.g., wireless and wireline bearers, different wireless bearers associated with different Radio Access Technologies (RAT), different wireline bearers associated with different wireline access technologies, different bearers associated with different Access Technologies (ATs), or the like). The PGW allocates downstream traffic flows among multiple downstream bearers in a policy-driven manner and, optionally, the CPE may allocate upstream traffic flows among multiple upstream bearers in a policy driven manner. The bonded service operation of the PGW and CPE is not expected to be relevant to the operation of SDF and AF endpoints, such as a UEs communicating with the CPE to receive traffic from various remote/public servers.

Various embodiments advantageously operate to increase throughput between a PGW and/or Broadband Network Gateway (BNG) and a CPE such as a residential/enterprise gateway by forming a multi-bearer bonded service therebetween using various wireless and/or wireline access technologies (e.g., DSL, cable, Wi-Fi, LTE, 3G wireless, and the like). Policies may be applied, at a residential or enterprise gateway for uplink traffic and/or at a PGW/SGW or combined PGW/BNG for downlink traffic, to spread traffic among multiple bearers within the context of bonded services. Various embodiments advantageously provide inherent error redundancy.

Various embodiments adapt and enforce policies across multiple access technologies and termination points. For example, some embodiments identify and bond together all available access technologies (e.g., combined wireless and wireline) in a subscriber management system and enforce policies for the downlink traffic. Various embodiments spread traffic loads across multiple access technology bearers using various techniques, such as hashing techniques and other allocation techniques. Various features (e.g., bonded service formation and structure, allocation of traffic among bearers, and so on) may be policy driven and dynamically updated as desired by one or more entities (e.g., the network operator, a subscriber management system, a network management system, or other entity).

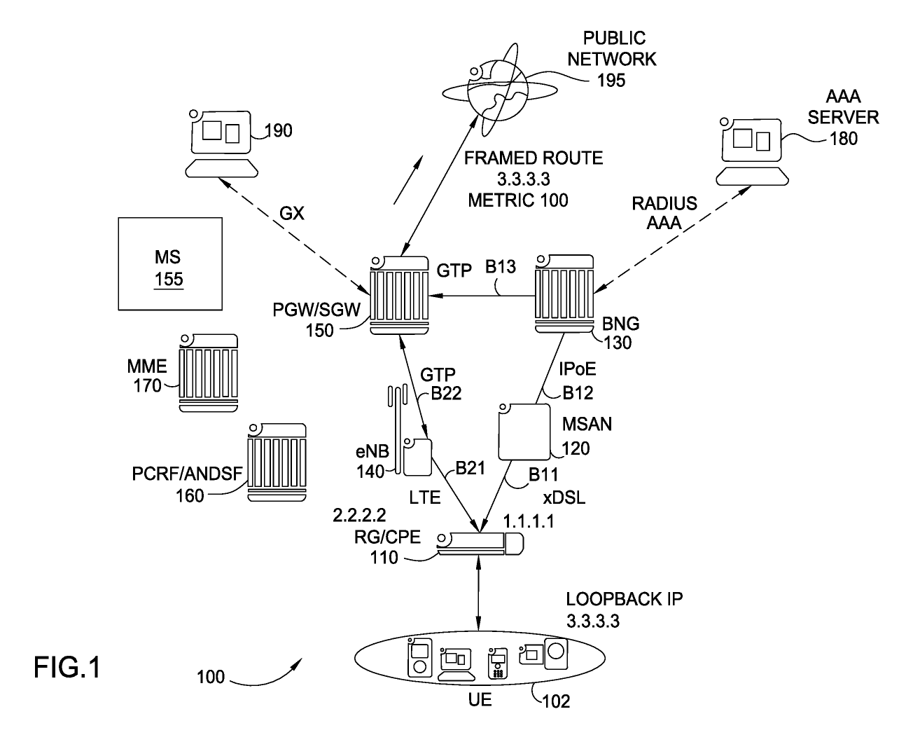

FIG. 1 depicts a high-level block diagram of a system benefiting from various embodiments.

The system 100 includes a User Equipment (UE) 102, a Residential Gateway/Customer Premises Equipment (RG/CPE) 110, a Multi-Service Access Node (MSAN) 120, a Broadband Network Gateway (BNG) 130, an evolved NodeB (eNodeB) 140, a combined Packet Gateway (PGW)/Serving Gateway (SGW) 150, a management system (MS) 155, a policy control entity 160, a Mobility Management Entity (MME) 170, an Authentication, Authorization and Accounting (AAA) server 180, a policy and charging enforcement function (PCEF) 190, and a public network 195. It is noted that, while system 100 of FIG. 1 is primarily described within the context of embodiments in which RG/CPE 110 comprises a Set-Top Box (STB) including both DSL and 3GPP/LTE access network capabilities, various other embodiments also are contemplated as will be discussed in more detail below. For example, within the context of a residential broadband gateway or other device, additional capacity can be added to a fixed cable television or DSL line by using LTE to increase upstream bandwidth and/or downstream bandwidth. Similarly, within the context of enterprise broadband gateway or other device, improved resilience and survivability may be provided via multiple bonded bearers.

The UE 102 may be a device such as a desktop computer, a laptop computer, a tablet computer, a set-top box, a smartphone, or any other fixed or mobile device capable of communicating with the RG/CPE 110. In various embodiments, UE 102 may be multi-homed to a gateway device (such as the PGW/SGW 150) via a first path or tunnel supported by the RG/CPE 110 and a second path or tunnel directly through a wireless access point (e.g., an eNodeB, a Wi-Fi Access Point (WAP), or other suitable wireless access point). It will be appreciated that, although primarily described with respect to a single UE 102, multiple UEs 102 may be used (illustrated in FIG. 1 as multiple example devices).

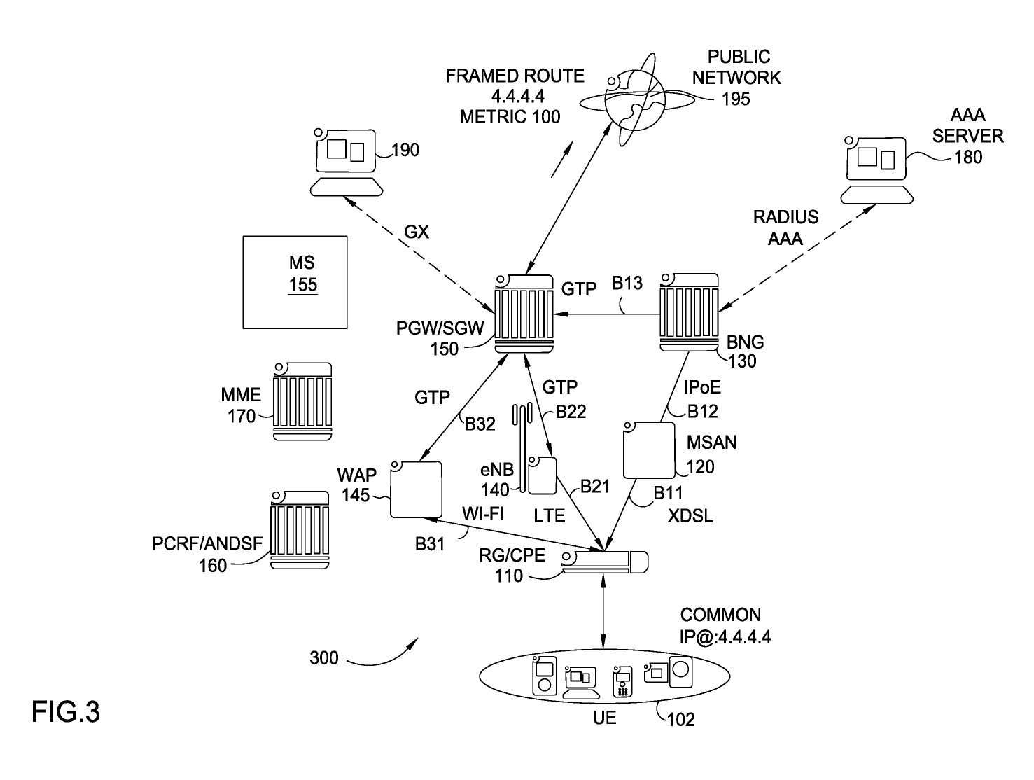

The RG/CPE 110 communicates with UE 102 to provide various network services thereto. The RG/CPE 110 is associated with, and communicates with PGW/SGW 150 via, at least two different access network technologies. As depicted in FIG. 1, the access network technologies include a wireless access network (illustratively, a 3GPP/LTE wireless access network) and a wireline access network (illustratively, an ×DSL wireline access network). It will be appreciated that, while only one wireless access network and one wireline access network are shown within the context of the system 100 of FIG. 1, more and/or different access networks also may be employed within various embodiments, such as described in more detail below with respect to FIG. 3. Further, various embodiments are applicable to any combination of two or more access technologies, which access technologies may comprise wireless access networks only, wireline access networks only, or a combination of wireless access networks and wireline access networks.

The RG/CPE 110 communicates with the PGW/SGW 150 via a wireline access network (illustratively an ×DSL access network) as well as a wireless access network (illustratively a Third Generation Partnership Project (3GPP)/Long Term Evolution (LTE) access network). It will be appreciated that other types of wireline access networks (e.g., optical access networks, cable access networks, or the like) and/or other types of wireless access networks (e.g., other types of cellular access networks, WiFi networks (e.g., managed WiFi access networks, unmanaged WiFi access networks, or the like), satellite links, or the like) may be used as access networks supporting a bonded service.

The ×DSL access network includes MSAN 120 supporting communications between the RG/CPE 110 and BNG 130. The BNG 130 communicates with the PGW/SGW 150, as well as the AAA server 180 (illustratively, a RADIUS server). The ×DSL access network may include or may be associated with various other management and/or control entities (not shown) as known to those skilled in the art. It is noted that the PGW/SGW 150 and BNG 130 are depicted in FIG. 1 as independent entities in communication with each other (illustratively, via a GTP tunnel); however, it will be appreciated that, in various embodiments, the PGW/SGW 150 and BNG 130 may be integrated within the same physical chassis to provide a converged packet core/BNG solution.

The 3GPP/LTE access network comprises eNodeBs 140 (although, for purposes of clarity, only a single eNodeB is depicted) supporting communications between the RG/CPE 110 and the PGW/SGW 150. As depicted in FIG. 1, the 3GPP/LTE access network may have associated therewith the policy control entity 160 (illustratively, implementing a Policy and Charging Rules Function (PCRF) and an Access Network Discovery and Selection Function (ANDSF) which, although depicted as a single entity or server, may be implemented in different entities or servers). As depicted in FIG. 1, 3GPP/LTE access network may have associated therewith MME 170. It will be appreciated that, while primarily discussed within the context of a 3GPP/LTE access network, various embodiments presented herein are also well suited for use with other types of wireless networks (e.g., 2G networks, 3G networks, other types of 4G networks, UMTS, EV-DO, WiMAX, 802.11, or the like, as well as various combinations thereof) and, thus, that the various elements (e.g., sites, nodes, network elements, connectors, or the like) discussed herein with respect to 3GPP/LTE embodiments also may be considered as being discussed with respect to similar elements in other wireless network embodiments (e.g., eNodeB 140 in the 3GPP/LTE access network may be referred to as a NodeB in a 3G UMTS network, PGW/SGW 150 in the 3GPP/LTE access network may be referred to as a GGSN/SGSN in a 3G UMTS network, and so forth).

In various embodiments, PGW/SGW 150 and RG/CPE 110 establish a user device data plane session therebetween in which the data plane provides two default bearers; namely, a first bearer tunnel through the first access network and a second bearer tunnel through the second access network. For example, the first bearer tunnel traversing the ×DSL access network may comprise a bearer link B11 between the RG/CPE 110 and the MSAN 120, a bearer link B12 between the MSAN 120 and the BNG 130, and a bearer link B13 between the BNG 130 and the PGW/SGW 150. For example, second bearer tunnel traversing the 3GPP/LTE access network may comprise a bearer link B21 between the RG/CPE 110 and eNodeB 140 and a bearer link B22 between the eNodeB 140 and the PGW/SGW 150. In various embodiments, the tunnels, bearers, and related session/traffic signaling conform to the General Packet Radio Service (GPRS) Tunneling Protocol (GTP). It will be appreciated that the tunnels, bearers, and related session/traffic signaling alternatively or also could conform to one or more other protocols.

The PGW/SGW 150 operates to forward downstream traffic to the RG/CPE 110 via the multiple access network technologies in accordance with a policy-driven allocation between multiple downstream tunnels or bearers forming a bonded service. The RG/CPE 110 operates to forward upstream traffic to the PGW/SGW 150 via one or more of the multiple access network technologies, optionally in accordance with a policy driven allocation between multiple upstream bearers forming a bonded service.

The PCRF/ANDSF 160 implements both PCRF and ANDSF functions. The PCRF provides dynamic management capabilities by which the service provider may manage rules related to UE user or subscriber Quality of Service (QoS) requirements, rules related to charging for services provided to the UE, rules related to mobile network usage, provider equipment management, and the like. The ANDSF assists the UE 102 and the RG/CPE 110 in discovering access networks (e.g., Wi-Fi networks, 3GPP/LTE networks, and the like) and provides rules governing connection policies associated with these access networks.

The MME 170 provides mobility management functions in support of mobility of UE 102 as well as RG/CPE 110. The MME 170 may support various eNodeBs (illustratively, eNodeB 140 as well as other eNodeBs which are omitted for purposes of clarity) using respective S1-MME interfaces (omitted from FIG. 1 for purposes of clarity) which provide control plane protocols for communication between the MME 170 and the eNodeBs 140.

In various embodiments, MS 155 provides management functions for managing one or more wireless and/or wireline networks, such as one or more of the 3GPP/LTE access network, the ×DSL access network, or the like. The MS 155 may communicate with the network(s) in any suitable manner. In various embodiments, for example, MS 155 may communicate with network elements via a communication path which may be in-band or out-of-band with respect to the various network elements. The MS 155 may be implemented as a general purpose computing device or specific purpose computing device, such as further described below. The MS 155 may interact with the PCRF/ANDSF 160 to provide management instructions, adapt policies, and perform various other functions.

In various embodiments, one or both of the PCRF and the ANDSF provides policy information to PGW/SGW 150 (and, optionally, RG/CPE 110) such that the PGW/SGW 150 (and, optionally, RG/CPE 110) are configured to support bonded services, provide policy-based path or bearer selection/routing rules for traffic flow assignment, and so on, as described herein with respect to the various embodiments. In various embodiments, PCRF-related actions pertain to policy delivery with respect to the PGW/SGW 150, while ANDSF-related actions pertain to policy delivery with respect to the RG/CPE 110 and/or UE 102.

In various embodiments, a mechanism for policy-based steering of user flows/applications between multiple bearers at various locations within the system 100 (e.g., at one or more of the PGW/SGW 150, the RG/CPE 110, and the UE 102) may be provided. The policies may be based upon one or more of traffic flows (e.g., streaming media, telephony, data transfer, secure session, or the like), applications (e.g., Netflix, Gmail, WebEx, or the like), entities (e.g., gold/silver/bronze level subscribers, content providers, service providers, or the like), or the like, as well as various combinations thereof. The policies may include respective policies identifying and invoking preferred access technologies.

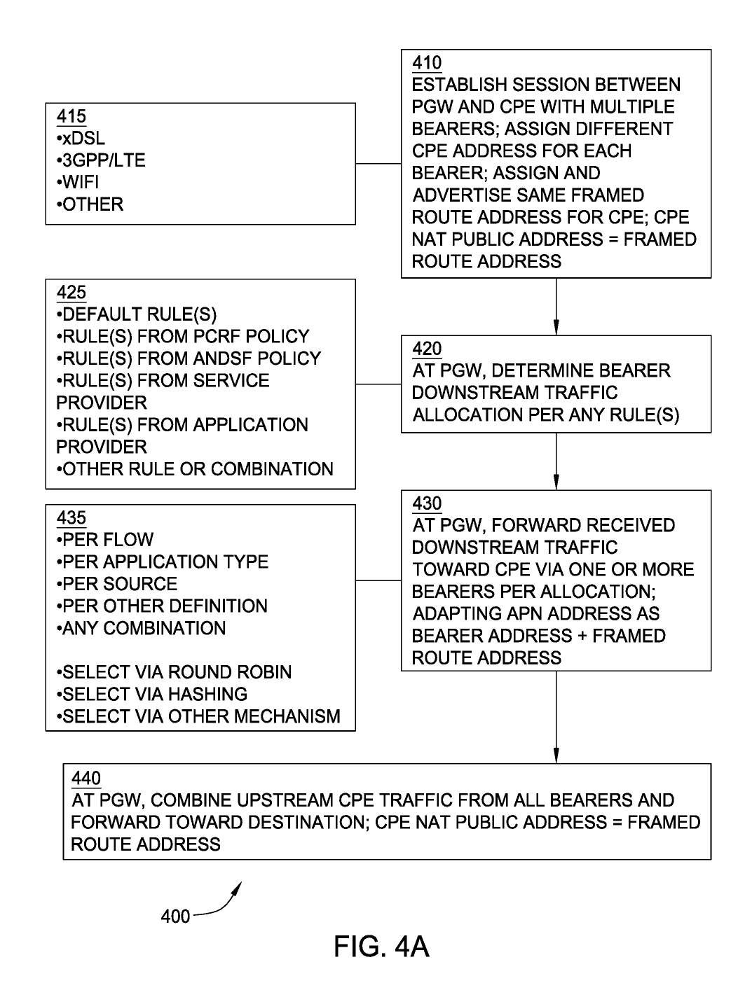

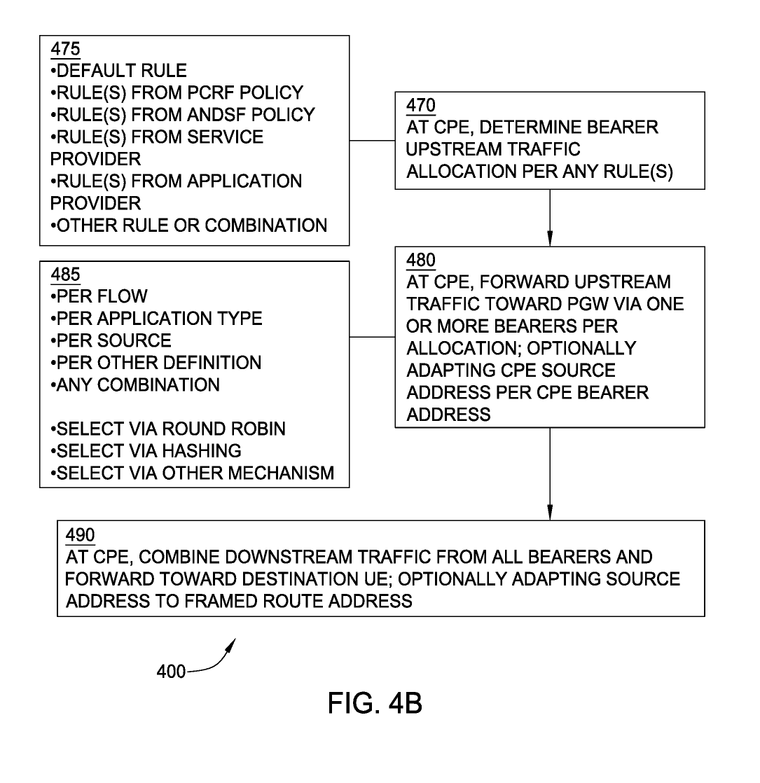

As depicted in FIG. 1, the system 100 has associated therewith exemplary CPE-related address indicators associated with data paths useful in explaining framed route embodiments, such as described below with respect to FIGS. 4A and 4B. The depicted CPE-related address indicators include a framed route address 3.3.3.3 (as well as the capacity metric depicted as 100) for traffic between the PGW/SGW 150 and a public network 195, an ×DSL link address of 1.1.1.1, an LTE link address of 2.2.2.2 and a CPE loopback address of 3.3.3.3. It is noted that the PGW/SGW 150 is an anchor point from an address perspective, allocating the same IP address to each of the bearers (e.g., 3GPP and non-3GPP access types) such that devices associated with public network 195 see only a single link to the UE 102 (even though that single link is actually composed of multiple bearers between the gateway devices serving the UE 102). It is noted that any of the various embodiments presented herein may be implemented within the various contexts adapted according to the embodiments, such as a network adapted according to any of the embodiments, a system adapted according to any of the embodiments, hardware and/or software adapted according to any of the embodiments, a management entity or network management system adapted according to any of the embodiments, a data center or computational resource adapted according to any of the embodiments, or the like.

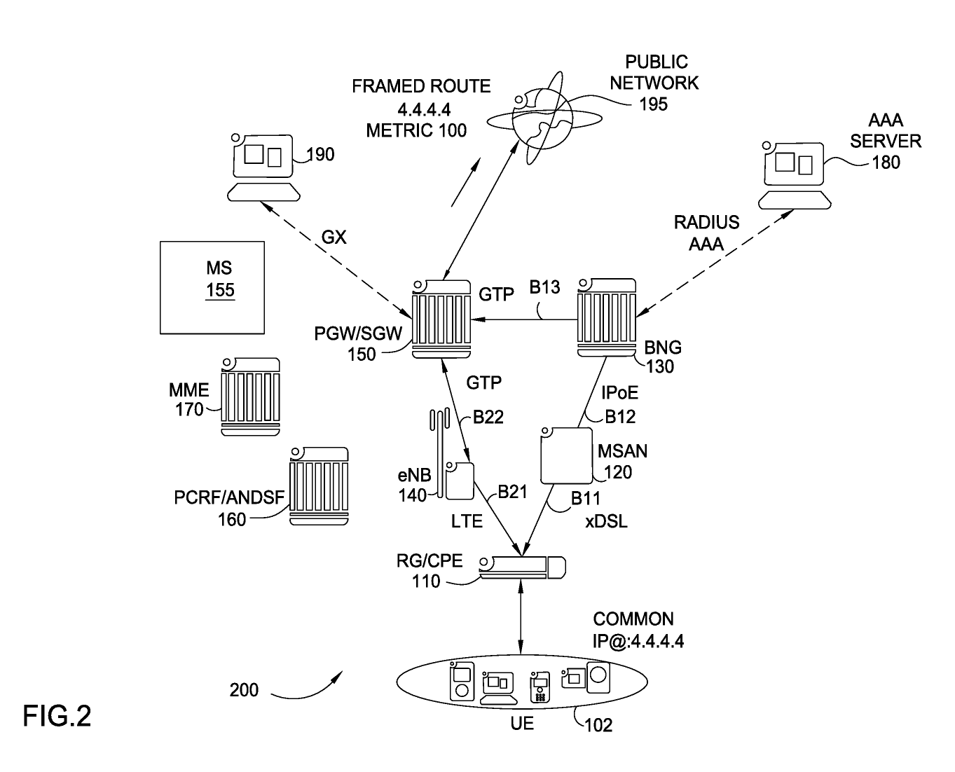

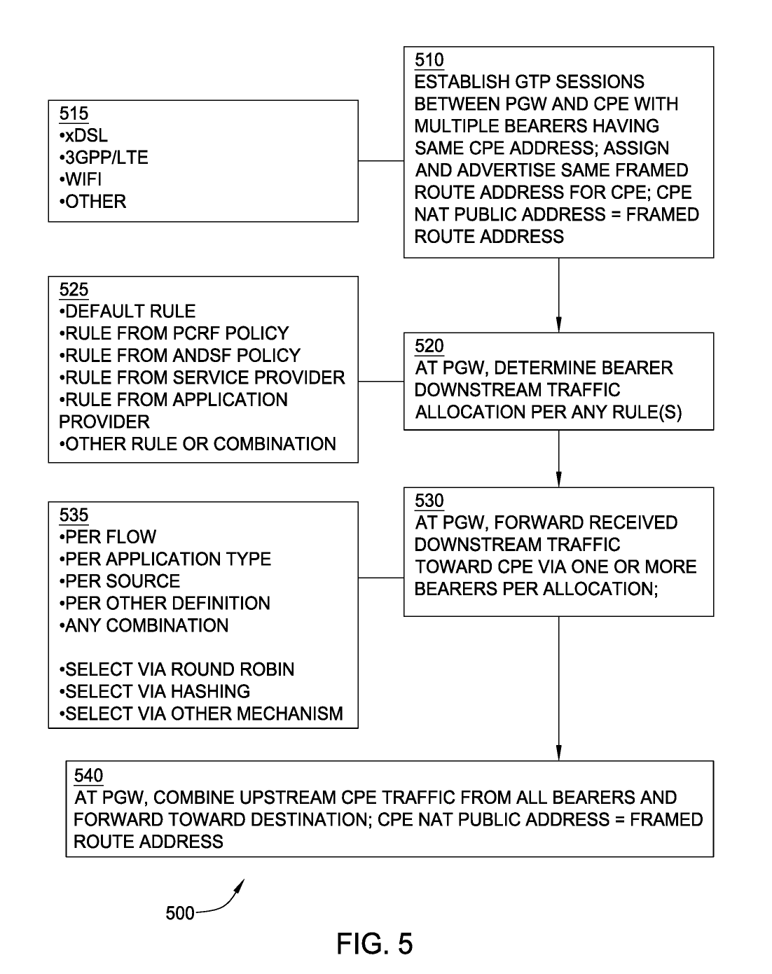

FIG. 2 depicts a high-level block diagram of a system 200 substantially the same as the system 100 depicted and described with respect to FIG. 1, with the exception that FIG. 2 further depicts various exemplary CPE-related address indicators useful in explaining embodiments that avoid problems associated with UE interaction, such as associated with IP Flow Mobility and Seamless Offload (IFOM) techniques, such as discussed in more detail below with respect to FIG. 5. The depicted CPE-related address indicators include a framed route address 4.4.4.4, which address is also used to identify the RG/CPE in each of the access networks. That is, only one address is used to identify the RG/CPE in these embodiments.

FIG. 3 depicts a high-level block diagram of a system 300 substantially the same as the system 200 depicted and described with respect to FIG. 2, with the exception that FIG. 3 further discloses a third access network and related bearer path (namely, a Wireless Access Point (WAP) 145 communicating with the RG/CPE 110 via a bearer B31 and with the PGW/SGW 150 via a bearer B32). The various embodiments described herein with respect to allocation of traffic associated with bearers through two access networks are readily adapted where three or more bearers through multiple access networks are provided.

Generally speaking, various embodiments contemplate policy-driven allocation of traffic across multiple bearers, where each bearer is associated with a different IP Connectivity Access Network (IP-CAN). However, in various embodiments it is contemplated that some of the bearers may be associated with the same IP-CAN.

In various embodiments, bonded services are supported. In general, a bonded service may be provided by binding together multiple data bearers through multiple access technologies (e.g., DSL, cable, Wi-Fi, LTE, 3G, satellite, or the like) between a network gateway element (e.g., Packet Gateway (PGW) or other network gateway element) and an end user related device (e.g., an RG, a CPE, a UE, or the like).

In various embodiments, based on Access Point Name (APN) configuration, the PGW determines the bonded property of the APN and includes an Attribute-Value Pair (AVP) to communicate the bonded property to the PCRF in an initial Credit Control Request (CCR-I). As an example, this could re-use IP-CAN-type with new type as BONDED. Further, a Bonded IP-CAN-type means an IP-CAN session where the UE may reach the EPC (PGW) over a 3GPP-EPS IP-CAN-Type and/or over a non-3GPP-EPS IP-CAN-Type, thus with a possible simultaneous access over both IP-CAN-Types. In addition, routing decisions are taken by a gateway network element (not a UE).

In various embodiments, Gx reporting from PCEF to the PCRF may indicate whether the UE or CPA is accessing the PGW over 3GPP access, over non-3GPP access, or over both kinds of access simultaneously. The Gx interface definition may be adapted to indicate that an updated Credit Control Request (CCR-U) may contain a RAT-Type or AT-Type indicator associated with a 3GPP-EPS IP-CAN-Type or a non-3GPP-EPS IP-CAN-Type. In various embodiments, the presence of both RAT-Types in a CCR-U will not be treated as inter-RAT handover, but, rather, as addition of a RAT or AT.

In various embodiments, the PCRF includes an IP-CAN-Type in the commands sent by the PCRF such that: (1) the presence of a given IP-CAN-Type in a PCRF command is interpreted to mean that the command applies only to this IP-CAN-Type and (2) the absence of the IP-CAN-Type in a PCRF command is interpreted to mean that the command applies to all IP-CAN-Types on the bonded IP-CAN session.

In various embodiments, for UEs capable of supporting the BONDED property, the UE may communicate this property by including a new container identifier (e.g., a bonded-support-request (MS to network) and a corresponding bonded-support (network to MS)). Similarly, a UE capable of supporting primary/backup support can communicate a redundancy-support-request (e.g., MS to Network, optionally with indication of a preferred PDN connection) and can receive a redundancy support response (e.g., Network to MS).

In various embodiments, the allocation or routing decision process takes into account various factors and policies.

In various embodiments, as long as both legs of the bonded service (e.g., 3GPP and non-3GPP) are established, for one direction (e.g., uplink (UL) or downlink (DL)), a given IP flow should be carried by a unique IP leg. This operates to avoid the condition wherein TCP packets/segments with a higher SN arrive before TCP packets/segments with a lower SN which have been transmitted via a faster error.

In various embodiments, flow based routing policies are provided. Specifically, PCRF policies may associate an SDF (e.g., a set of IP filters) or an AF with a preferred IP-CAN-Type (3GPP/non-3GPP) and allocate/route accordingly.

In various embodiments, global routing policies are provided. Specifically, global routing policies may be applied when no flow-based routing policies are provided for traffic that must be allocated by, illustratively, the PGW. Some examples of global policies include:

(1) a priority and a priority throughput are associated with one IP-CAN-Type, such as a least cost IP-CAN-Type (likely to be non-3GPP (e.g., DSL));

(2) a relative load factor (%) is provided for different RAT-Type combinations (e.g., RAT-Type of 3GPP IP-CAN-Type, RAT-Type of non-3GPP IP-CAN-Type, and so on) where the relative load factor may be used in various embodiments to establish a configuration (active/stand-by) where all traffic is sent on a given IP-CAN-Type; and

(3) a Priority IP-CAN-Type, in which priority throughput and relative load factors may be either locally configured on the PGW or sent by the PCRF over Gx (where, in the latter case, the priority throughput and relative load factors are associated with the Gx session and override the locally configured value(s)).

Various routing/allocation processes may be configured to subject traffic to global routing policies. In particular, in various embodiments, the PGW measures the actual throughput on each of the bearers and, as long as the actual throughput on a priority bearer or leg is below the priority throughput defined for that bearer or leg, the traffic is sent on the priority bearer or leg. Once the priority access bearer or the like is loaded up to its priority throughput threshold level, the PGW uses the relative load factor (%) associated with the IP-CAN-Type (3GPP/non-3GPP) to ensure load sharing.

In various embodiments, framed route capabilities are supported. In general, a framed route embodiment may be provided within the context of a bonded service by assigning a different address for each bearer of the bonded service, assigning a framed route address for the end device (e.g., CPE or UE) for which the bonded service is provided (e.g., CPE or UE), advertising the framed route address as a Natural Address Translation (NAT) public address of the end device, wherein remote network entities (e.g., application servers or the like) address traffic to the end device via the framed route address (NAT public address) and a gateway serving the end device is configured to address traffic to the end device via the different addresses associated with the established bearers of the bonded service. Various framed route embodiments may be further understood by way of reference to FIGS. 4A and 4B-FIG. 6.

FIGS. 4A and 4B depict a flow diagram of a method according to various embodiments. Specifically, FIGS. 4A and 4B depict a framed route mechanism suitable for use within the systems of FIGS. 1-3, wherein actions performed at the PGW/SGW 150 are primarily depicted in steps 410-440 of FIG. 4A, while actions performed at the RG/CPE 110 are primarily depicted in steps 460-490 of FIG. 4B.

Referring to FIG. 4A, at step 410, a session is established between the PGW and the CPE via multiple bearers (e.g., one bearer (e.g., GTP tunnel or the like) traversing each of a wireless access network and a wireline access network therebetween). The CPE is assigned a different address for each bearer. Further, a framed route address is assigned to the CPE and advertised as the NAT public address of the CPE. In this manner, remote network entities (such as application servers and the like) address traffic to the CPE via the NAT public address (framed route address), while the PGW addresses traffic to the CPE via specific addresses associated with the established bearers. Referring to box 415, the access network may include wireline access networks such as ×DSL and/or wireless access networks such as 3PP/LTE, Wi-Fi, or the like.

At step 420, the PGW determines a bearer downstream traffic allocation based on any allocation rules, such as default and/or policy-driven rules. Referring to box 425, the allocation rules may include one or more default rules, one or more rules received within policy information from a PCRF or ANDSF, one or more rules received from one or more entities (e.g., one or more rules received from a service provider, one or more rules received from an application provider, one or more rules received from one or more other entities), or the like, as well as various combinations thereof.

At step 430, the PGW forwards received downstream traffic (e.g., received from the public network 195) toward the CPE via one or more bearers in accordance with the determined bearer downstream traffic allocation. Further, the PGW adapts the APN address of the downstream traffic according to the bearer address and framed route address. Referring to box 435, the bearer downstream traffic allocation may be applied on the basis of various techniques/criteria, such as per flow, per application type, per source, per some other definition, or per any combination of these techniques/criteria. Referring to box 435, the bearer downstream traffic allocation may be performed by any mechanism, including round robin, weighted preferences, percentage, hashing, other mechanism, or per any combination of these mechanisms.

At step 440, the PGW combines upstream CPE traffic from all bearers and forwards the combined traffic toward the appropriate destination. That is, the PGW receives upstream traffic or packets from the CPE, combines the received traffic, replaces the CPE bearer-related source IP address with the NAT public address (framed route address), and forwards the combined traffic or packets toward the appropriate destination.

Generally speaking, the steps contemplated with respect to the embodiments of FIGS. 4A and 4B are suitable for use within the context of the systems described with respect to FIGS. 1-3. As an example, ×DSL and LTE sessions may be provided as follows:

×DSL: IP over Ethernet (IPoE) session to the BNG->AAA assigns IMSI X based on MAC and default APN ×DSL->GTPv2 session/bearer setup to PGW with IP address assignment (1.1.1.1)+framed route 3.3.3.3+Gx session; and

LTE: GTPv2/bearer setup with IMSI X, APN LTE->IP address assignment (2.2.2.2)+framed route 3.3.3.3.

Thus, with respect to the PGW, two PDN sessions with the same subscriber identity (e.g., International Mobile Subscriber Identity (IMSI)) are provided, each with a different APN, wherein the same NAT public address (framed route address) is used on both PDN sessions.

In various embodiments, allocation of traffic between the two access networks may be determined by a number of methods, such as equal-cost multipath (ECMP) hashing within the context of an “any/any” PCC (Policy Control and Charging) rule. Further, other PCC rules may be provided to allocate or direct traffic either via ×DSL or LTE.

In various embodiments, one NAT public address (framed route address) associated with the CPE is advertised to public network elements, such as within the context of an IPv6 framed route solution. This one NAT public address (framed route address) is used by upstream CPE traffic of the CPE as a source address for each link or bearer by which upstream traffic is communicated to the PGW.

In various embodiments, multiple public NAT addresses may be used for the CPE for multiple access networks, and upstream traffic may be passed or otherwise allocated between the multiple access networks if desired. In various embodiments, substantially all traffic is allocated to a preferential access network (e.g., the ×DSL access network), while traffic in excess of a threshold amount is allocated to a secondary access network (e.g., the LTE access network). In various embodiments, upstream traffic is hashed via LTE/×DSL, IPv6 Dynamic Host Configuration Protocol (DHCP) Prefix Delegation (PD).

Referring to FIG. 4B, at step 470 the CPE determines a bearer upstream traffic allocation based on any allocation rules, such as default and/or policy-driven rules. Referring to box 475, the allocation rules may include one or more default rules, one or more rules received within policy information from a PCRF or ANDSF, one or more rules received from one or more entities (e.g., one or more rules received from a service provider, one or more rules received from an application provider, one or more rules received from one or more other entities), or the like, as well as various combinations thereof.

At step 480, the CPE forwards received upstream traffic (e.g., received from the UE 102) toward the PGW via one or more bearers in accordance with the determined bearer upstream traffic allocation. Further, the PGW adapts the CPE source address for upstream traffic in accordance with the CPE bearer related address. Referring to box 485, the bearer upstream traffic allocation may be applied on the basis of various techniques/criteria, such as per flow, per application type, per source, per some other definition, or per any combination of these techniques/criteria. Referring to box 485, the bearer upstream traffic allocation may be performed by any mechanism, including round robin, weighted preferences, percentage, hashing, one or more other mechanisms, and/or any combination of these mechanisms.

At step 490, the CPE combines downstream traffic from all bearers and forwards the combined traffic toward the appropriate destination (e.g., toward the UE 102). That is, the CPE receives downstream traffic or packets from the PGW, combines the received downstream traffic, replaces the bearer-related source IP address with the NAT public address (framed route address), and forwards the combined traffic or packets toward their appropriate destination UE.

FIG. 5 depicts a flow diagram of a method according to various embodiments. Specifically, FIG. 5 depicts a mechanism suitable for use within the systems of FIGS. 1-3. Specifically, FIG. 5 depicts a framed route mechanism suitable for use within the systems of FIGS. 1-3, wherein actions performed at the PGW/SGW 150 are primarily depicted in steps 510-540 of FIG. 5, while actions performed at the RG/CPE 110 are omitted from FIG. 5 since they are substantially the same as the actions performed by RG/CPE 110 in steps 450-490 of method 400 of FIG. 4B.

At step 510, a session is established between the PGW and the CPE via multiple bearers, (e.g., one bearer (e.g., GTP tunnel or the like) traversing each of a wireless access network and a wireline access network therebetween). The CPE is assigned the same IP address for each bearer. Further, the same address is used and advertised as the NAT public address of the CPE. Referring to box 515, the access network may include wireline access networks such as ×DSL and/or wireless access networks such as 3PP/LTE, Wi-Fi, or the like.

At step 520, the PGW determines a bearer downstream traffic allocation based on any allocation rules, such as default and/or policy-driven rules. Referring to box 525, the allocation rules may include one or more default rules, one or more rules received within policy information from a PCRF or ANDSF, one or more rules received from one or more entities (e.g., one or more rules received from a service provider, one or more rules received from an application provider, one or more rules received from one or more other entities), or the like, as well as various combinations thereof.

At step 530, the PGW forwards received downstream traffic (e.g., received from the public network 195) toward the CPE via one or more bearers in accordance with the determined bearer downstream traffic allocation. Further, the PGW adapts the APN address of the downstream traffic according to the bearer address and framed route address. Referring to box 535, the bearer downstream traffic allocation may be applied on the basis of various techniques/criteria, such as per flow, per application type, per source, per some other definition or per any combination of these techniques/criteria. Referring to box 535, the bearer downstream traffic allocation may be performed by any mechanism, including round robin, weighted preferences, percentage, hashing, other mechanism, or per any combination of these mechanisms.

At step 540, the PGW combines upstream CPE traffic from all bearers and forwards the combined traffic toward the appropriate destination. That is, the PGW receives upstream traffic or packets from the PE, combines the received traffic, replaces the CPE bearer-related source IP address with the NAT public address (framed route address), and forwards the combined traffic or packets toward the appropriate destination.

Generally speaking, the steps contemplated with respect to the embodiments of FIG. 5 are suitable for use within the context of the systems described with respect to FIGS. 1-3. As an example, ×DSL and LTE sessions may be provided as follows:

×DSL: IPoE session to the BNG->AAA assigns IMSI X based on MAC and APN Y->GTPv2 session/bearer setup to PGW with IP address assignment (4.4.4.4)+Gx session; and

LTE: GTPv2/bearer setup with IMSI X, APN Y->IP address assignment (4.4.4.4).

Thus, with respect to the PGW, there are provided two bearers on given PDN sessions.

In various embodiments, allocation of traffic between the two access networks may be determined by a number of methods, such as ECMP hashing within the context of an “any/any” PCC rule. Further, other Policy Control and Charging (PCC) rules may be provided to allocate or direct traffic either via ×DSL or LTE.

In various embodiments, one NAT public address (framed route address) associated with the CPE is advertised to public network elements. This one NAT public address (framed route address) is used by upstream CPE traffic of the CPE as a source address for each link or bearer by which upstream traffic is communicated to the PGW.

In various embodiments, multiple public NAT addresses may be used for the CPE for multiple access networks, and upstream traffic may be passed or otherwise allocated between the multiple access networks if desired. In various embodiments, substantially all traffic is allocated to a preferential access network (e.g., the ×DSL access network), while traffic in excess of a threshold amount is allocated to a secondary access network (e.g., the LTE access network). In various embodiments, upstream traffic is hashed via LTE/×DSL, IPv6 DHCP PD. In various embodiments, a default any/any rules is hashed across both PDN sessions.

As noted herein, within the context of the method 500 of FIG. 5, the CPE operates in substantially the same manner as that described herein with respect to FIG. 4B.

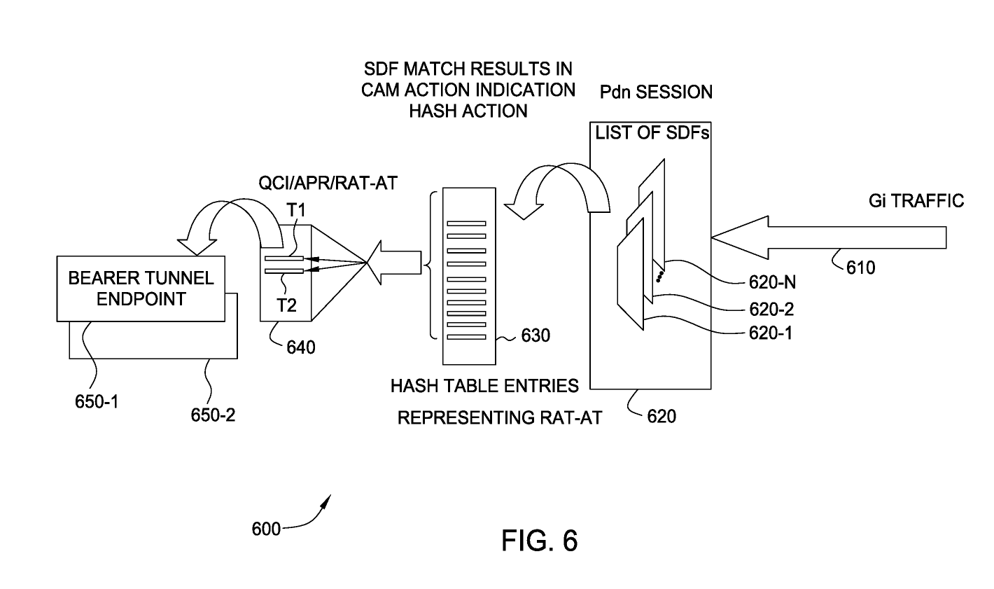

FIG. 6 depicts a graphical representation of a data plane model useful in understanding various embodiments. Specifically, FIG. 6 depicts a data plane processing model suitable for understanding access network traffic allocation processes occurring at various elements (e.g., the PGW, the CPE, or one or more other devices) in accordance within the various embodiments. Referring to FIG. 6, Gi traffic or other traffic 610 is received by a device operating in accordance with various embodiments presented herein. The packet data network session 620 may include a plurality of Service Data Flows (SDFs) depicted as SDFs 620-1 through 620-N.

In various embodiments, each of the SDFs is associated with identification information or other information useful in hashing the SDF or portions thereof such that the SDF or portions thereof may be allocated to one or more of a plurality of bearers in communication with a destination device, such as a CPE device for downstream traffic or a PGW for upstream traffic.

In various embodiments, each of the SDFs is associated with a QoS Class Indicator (QCI)/Address Resolution Protocol (ARP) key (denoted as a QCI/ARP key). The QCI/ARP key may be used within the context of hashing an SDF or portion thereof to thereby allocate the SDF or portion thereof to a particular bearer in communication with the destination device. That is, an entry in a hash table 630, responsive to hashing the SDF or portion thereof, indicates the appropriate bearer for communicating the SDF or portion thereof to the destination device. This indication may take the form of, illustratively, a RAT indicator or, more generally, an AT indicator. The RAT/AT indicator may be added to the existing QCI/ARP key to form a QCI/ARP/RAT (or QCI/ARP/AT) key, which key may be used to direct the SDF or portion thereof to the appropriate bearer in communication with the destination device (e.g., one of tunnels T1 and T2 within a plurality of bearers 640 configured to forward traffic to the appropriate bearer tunnel endpoint (e.g., 650-1 or 650-2)) and, thus, to the appropriate destination device (e.g., UE or other destination device).

In various embodiments, “traffic hash profiles” may be configured to describe the traffic distribution across the different types of access networks. For example, a default traffic hash profile may provide for 100%/0% distribution wherein a first access type receives 100% of traffic while the second access type receives 0% traffic. The hash profiles may be expanded to include more than two access types. Various embodiments contemplate default profiles of 100%/0% for each access network.

Generally speaking, a bonded service according to various embodiments is implemented with a user device data plane session having two or more default bearers capable of carrying traffic flows for a subscriber (e.g., SDFs or portions thereof). As previously discussed, allocation of traffic to the various bearers may be policy-driven. The allocation of traffic to the various bearers may be implemented using hashing or any other mechanism suitable for selectively routing traffic flows, such as SDFs or portions thereof, to various upstream or downstream endpoints.

In various embodiments, a bonded service may be defined as a service where: (1) a UE or RG/CPE is simultaneously served by the same IP address over both 3GPP and non-3GPP access networks and (2) the PGW (not the UE) determines which IP-CAN-Type to use for a given DL IP flow. In various embodiments, UE multi-homing is provided wherein the PGW is better positioned than the UE to determine which IP-CAN-Type to use for a given DL IP flow. Generally speaking, this may happen when the UE (or RG/CPE) is served by 3GPP and non-3GPP access networks that are stable enough such that there is no issue as to whether the network chooses the IP-CAN-Type to use for a given DL IP flow and (2) the UE or RG/CPE cannot or does not have SDF or application flow knowledge. In these embodiments, the PGW may base the decision on (dynamic) PCRF policies or on information from AAA server.

It is noted that one embodiment is well suited for use within the context of the PGW simultaneously connected to a RG/CPE via both DSL (a DSL bearer) and LTE (an LTE bearer), wherein upstream and/or downstream traffic is preferentially routed via the DSL bearer to threshold level approaching a maximum bandwidth of, illustratively, 100 Mb per second, and wherein further traffic is routed via the LTE bearer.

It is noted that various embodiments discussed herein may be applicable to numerous applications, such as supporting faster handover (HO) between 3GPP and non-3GPP. That is, when a PDN connection is simultaneously set up on both 3GPP and non-3GPP access networks, a sudden loss of access via a primary access network does not induce a service interruption gap for the UE to attempt a recovery operation by setting up the PDN connection again on the other access network. In this case, the various access networks may operate in active/standby mode or in active/active mode, wherein active/active mode supports a higher throughput.

In various embodiments, a bonded service may be associated with a UE that is multi-homed for a given IP-CAN session. However, there is one single IP-CAN session associated with the IP address/IPv6 Prefix of the UE. In this manner, the single IP-CAN session providing multiple data plane sessions allows for simple flow management for charging (e.g., via Gy interface, Gz/Rf/Ga interfaces, or the like) and lawful interception (LI) interfaces, for traffic detection function (TDF) interactions, and so forth.

In various embodiments, the bonded service provides the PGW control over DL routing decisions based on PCRF instructions (thus needing the creation of a new AVP over the Gx interface). Within the context of various embodiments, the routing decisions are communicated to the PCRF via a Routing-Rule-Install AVP. The PCRF may use this information to create/update/delete PCC rules.

It is noted that the various embodiments described herein generally relate to a use case wherein a CPE has both DSL and LTE access capability, such as at a residential or enterprise gateway. These embodiments provide a mechanism by which LTE bearers, when bonded with DSL bearers, provide additional bandwidth and resiliency to customers as discussed herein.

Various embodiments contemplate 3GPP/LTE/Wi-Fi/DSL bonding services in multiple combination. For example, the various LTE/DSL bonding services described herein may be equally applicable to Wi-Fi/LTE bonding, Wi-Fi/3GPP bonding, Wi-Fi/LTE/DSL bonding, DSL/satellite bonding, or various other multiple access network bonding services in which a single IP address is used for each of the multiple access bearers or sessions of the UE. A description of an embodiment of Wi-Fi/LTE bonding, in which the UE (or RG/CPE) uses both LTE and Wi-Fi together as part of a bonded service, follows. Advantageously, by assigning one IP address to the UE for use in both LTE as well as trusted Wi-Fi access, unwanted inter-RAT handover problems may be avoided. To illustrate, at present, if a UE such as a handset is enabled to have both LTE and Wi-Fi access, it is assumed that both connections receive separate IP addresses; however, in the case of a trusted WLAN where the handset communications via Wi-Fi are sent to the same PGW as LTE communications, the PGW may treat data received via multiple access networks as indicating a need for inter-RAT handover such that the PGW tears down the LTE session. Since the handset is not expecting to be disconnected from the LTE connection, the handset attempts to reconnect to the PGW, thereby triggering at the PGW an inter-RAT handover from Wi-Fi to LTE. It is noted that, in various such bonded services, allocating the same IP address for multiple connections helps in limiting address space usage without impacting the core routing domain.

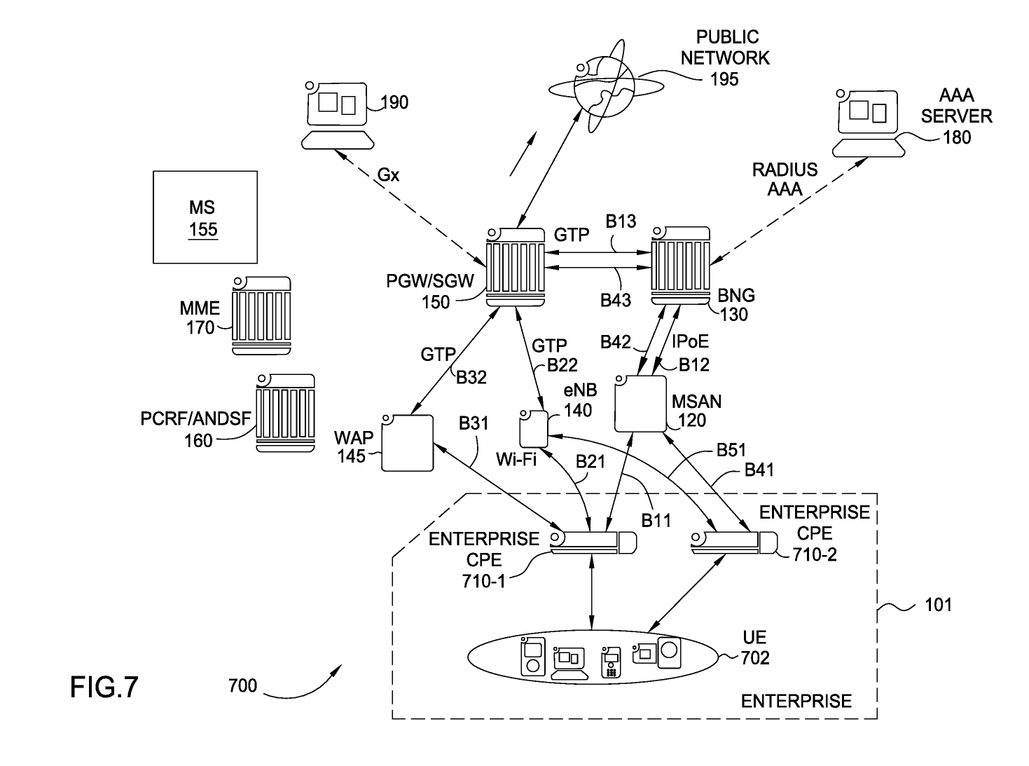

In various embodiments, bonded services may be utilized within an enterprise context to support a resilient enterprise CPE (e.g., router or edge gateway (EG)) pair or group. In this manner, bonding services may be adapted to improve enterprise resiliency. For example, assume that an enterprise network includes two routers connected to a PGW for resiliency purposes. It is noted that each of these two routers typically would be identified by a separate subscriber identifier (e.g., an International Mobile Subscriber Identifier (IMSI) or other suitable identifier). That is, in contrast to the single CPE examples discussed herein, each of the routers (CPEs) forming the resilient router pair is associated with a respective subscriber identifier (e.g., IMSIs) such that there are two disparate connections identifying two different subscriber identifiers (e.g., IMSIs) which may be bonded together as well to give resilience or a traffic distribution preference. Various enterprise resilient CPE pair embodiments may be further understood by way of reference to FIG. 7.

FIG. 7 depicts a high-level block diagram of a system 700 substantially the same as the system 300 depicted and described with respect to FIG. 3, with the exception that FIG. 7 further discloses a second CPE. As depicted in FIG. 7, an enterprise 701 includes a first enterprise CPE 710-1 (e.g., a first enterprise router or edge gateway (EG)) and a second enterprise CPE 710-2 (e.g., a second enterprise router or edge gateway (EG)), which may be referred to collectively as enterprise CPEs 710. The enterprise CPEs 710 form a resilient enterprise CPE pair (e.g., a resilient enterprise router pair or EG pair). As depicted in FIG. 7, each of the enterprise CPEs 710 (e.g., enterprise routers) is configured to communicate with the UE 702 (or with different UEs 102 where multiple UEs 102 are supported).

The first enterprise CPE 710-1 is associated with a first subscriber identifier (e.g., IMSI) and receives bonded services including bearer paths through DSL (B11, B12, B13), LTE (B21, B22) and Wi-Fi (B31, B32) access technologies. It is noted that the bonded services are provided to first enterprise CPE 710-1 in the manner described herein with respect to the various figures.

The second enterprise CPE 710-2 is associated with a second subscriber identifier (e.g., IMSI) and receives bonded services including bearer paths through DSL (B41, B42, B43) and LTE (B51, B52) access technologies. It is noted that the bonded services are provided to second enterprise CPE 710-2 in the manner described herein with respect to the various figures.

In FIG. 7, the PGW/SGW 150 provides a bonded session for the connections of the first enterprise CPE 1710-1 and the connections of the second enterprise CPE 710-2 to form thereby a resilient bonded session. More specifically, PGW/SGW 150 identifies that both connections are associated with enterprise 701 and, therefore, that traffic destined for the UE 702 within the enterprise 701 may be provided via one or both of the first and second enterprise CPEs 110. In some embodiments, in which enterprise 701 includes multiple UEs 702, each of the enterprise CPEs 110 communicates with any of the UEs 702. In some embodiments, in which enterprise 701 includes multiple UEs 702, each of the enterprise CPEs 710 communicates with a subset of the UEs 102, which subset may overlap to include one or more commonly serviced UEs 702. In various embodiments, a resilient bonded session may allocate traffic among any of the bearers servicing the enterprise CPEs 710. In various embodiments, one of the enterprise CPEs 710 may operate as a primary/active enterprise CPE 710, while the other enterprise CPE 710 operates as a secondary/standby enterprise CPE 710. Various other configurations will also be appreciated by those skilled in the art.

In various embodiments, connections from multiple routers, such as routers serving a common enterprise or portion thereof, may be bonded together. In various embodiments, a bonded resilience Information Element (IE) may be associated with priority information, enterprise identification information, and/or other information or parameters.

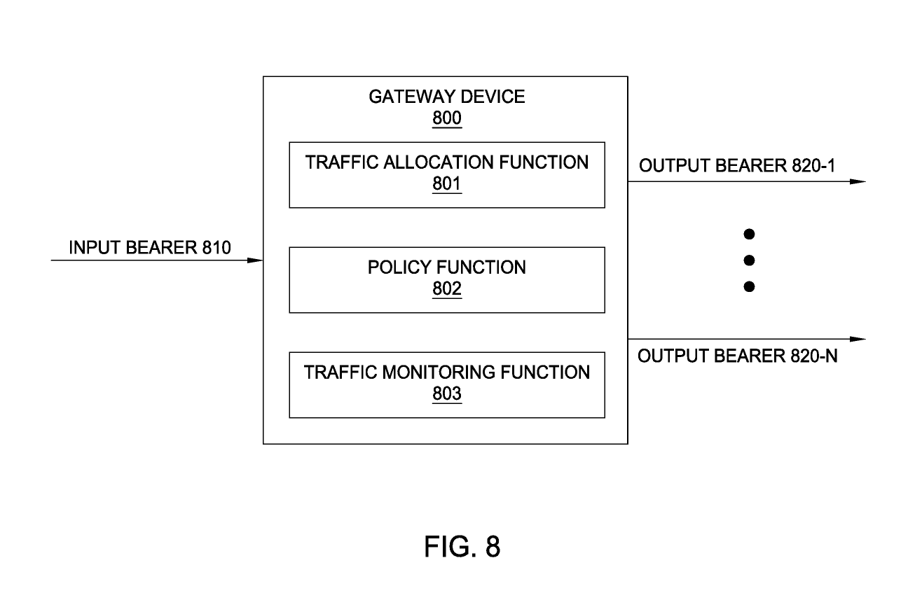

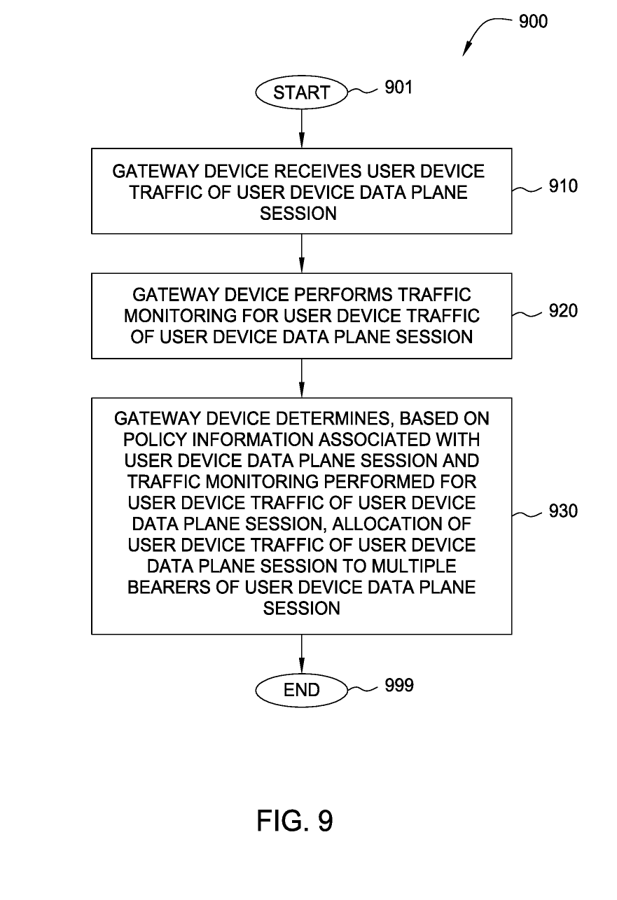

Various embodiments contemplate providing a bonded service by (1) determining, at a gateway device configured to support a UE data plane session having multiple bearers, an allocation of UE traffic communicated by the multiple bearers according to policy information received by the gateway device, wherein each bearer is associated with a different access network (e.g., IP-CAN and (2) adapting UE traffic communicated via the multiple bearers according to the determined allocation of UE traffic. The UE traffic may include any type of traffic, such as SDFs, AFs, and the like. The access networks (e.g., IP-CANs) may include any type of access network technologies, such as DSL, WiFi, WiMAX, 3GPP/LTE, cable television, or the like. The allocating may be determined based on a maximum fill link traffic allocation capability that uses active traffic monitoring and policy information for traffic allocation, as depicted and described with respect to FIG. 8 and FIG. 9. The allocating of the UE traffic across the bearers based on the determined allocation may be implemented on a per-flow basis (e.g., by hashing on flows to direct flows to the bearers), for traffic independent of flows (e.g., by hashing the traffic to spread the traffic across the multiple bearers, or at other levels of granularity. In various embodiments, policy information pertaining to downstream traffic allocation across bearers may be provided to the PGW/SGW via one or both of a PCRF or ANDSF. In various embodiments, policy information pertaining to upstream traffic allocation across bearers may be provided to the CPE or the UE via one or both of the PCRF or ANDSF, or via communications propagated to the CPE or the UE from the PGW/SGW. In various embodiments, downstream or upstream traffic allocations among the multiple bearers may be adapted in response to one or more of access technology congestion levels, updated policies, updated service level agreement (SLA) requirements, and so forth.

It is noted that various embodiments contemplate an apparatus including a processor and memory, where the processor is configured to establish multiple-bearer data sessions, allocate traffic among the various bearers of the multiple-bearer data sessions, interact with policy control entities, and generally perform the functions described herein with respect to the PGW processing of downstream traffic, CPE or UE processing of upstream traffic, and so forth. The processor is configured to perform the various functions as described, as well communicate with other entities/apparatuses including respective processors and memories, to exchange control plane and data plane information in accordance with the various embodiments.

In various embodiments, a maximum fill link capability may be supported for a bonded session.

The maximum fill link capability may be configured to control allocation of user device traffic of a user device across multiple bearers of a bonded data plane session supported for the user device.

The maximum fill link capability may be provided at a gateway device associated with the bonded data plane session, which may be a network gateway device (e.g., PGW) for downstream user device traffic or a customer gateway device (e.g., CPE) for upstream user device traffic. The maximum fill link capability may be configured to enable a gateway device, based on active traffic monitoring (e.g., active traffic rate monitoring) to efficiently or optimally use the bearer capacities of the bearers of the bonded data plane session (e.g., a bearer of a preferred access type is used/filled with traffic of the bonded data plane session first and when the traffic rate of the traffic on the bearer of the preferred access type exceeds or may exceed the capacity of the bearer of the preferred access type, as determined based on active traffic rate monitoring, excess traffic of the bonded data plane session may be directed onto one or more other bearers of the bonded data plane session).

The maximum fill link capability may be configured to control allocation of user device traffic of a user device across multiple bearers of a bonded data plane session supported for the user device based on policy information. The maximum fill link capability may be configured to control allocation of user device traffic of a user device across multiple bearers of a bonded data plane session supported for the user device based on policy information and based on active traffic monitoring of user device traffic of the bonded data plane session supported for the user device. The use of active traffic monitoring of the traffic of the bonded data plane session supports policies for filling (or partially filling) the bearer of a primary (or preferred) access type of the bonded data plane session before using the bearer of a secondary access type of the bonded data plane session, where the primary access type of the bonded data plane session may be preferred over the secondary access type of the bonded data plane session based on various factors or parameters (e.g., bearer data rate, bearer throughput, bearer cost, or the like, as well as various combinations thereof). The use of active traffic monitoring may convert policies that might otherwise be static or substantially static into policies that are dynamic or potentially dynamic. The use of active traffic monitoring enables the allocation of traffic of the bonded data plane session in a manner that not only accommodates bursts of traffic within the bonded data plane session (which, in some instances, may be accommodated even with the use of static or substantially static policies), but also provides more intelligent and flexible distribution of traffic across the bearers of the bonded data plane session.

These and various other embodiments of the maximum fill link capability may be further understood by way of reference to FIG. 8.

FIG. 8 depicts a high-level block diagram of a gateway device configured to support a maximum fill link capability for a bonded session.

As depicted in FIG. 8, the gateway device 800 is configured to receive traffic via an input bearer 810 and allocate the traffic to a set of output bearers 820-1-820-N (collectively, output bearers 820). The output bearers 820 correspond to bearers of a bonded data plane session and, thus, traffic received via the input bearer 810 represents the traffic of the bonded data plane session and the traffic output via the output bears 820 represents respective portions of the traffic of the bonded data plane session that are allocated to the output bearers 820 in accordance with the bonded session. The gateway device 800 may be a network gateway device (e.g., a gateway from a provider core network to a public data network, such as a PGW operating as a gateway between the core wireless network and one or more public data networks) or a customer premises gateway device (e.g., a gateway between a customer premises and a provider network, such as a CPE operating as a gateway to a provider network for one or more user devices (e.g., UEs)). In the case in which the gateway device 800 is a network gateway device, the direction of traffic flow may be in the downstream direction from the network gateway device to a customer premises device (e.g., the output bearers 820 are established between the network gateway device and the customer premises gateway device). In the case in which the gateway device 800 is a customer premises gateway device, the direction of traffic flow may be in the upstream direction from the customer premises gateway device to a network gateway device (e.g., the output bearers 820 are established between the customer premises gateway device and the network gateway device). It will be appreciated that the gateway device 800 may be disposed at other locations within networks.

As further depicted in FIG. 8, the gateway device 800 includes a traffic allocation function 801, a policy function 802, and a traffic monitoring function 803.

The traffic allocation function 801 is configured to allocate traffic of the bonded data plane session (i.e., received via input bearer 810) to the output bearers 820 of the data plane session. The traffic allocation function 801 may be configured to allocate traffic of the bonded data plane session to the output bearers 820 of the data plane session based on policy information from policy function 802. The traffic allocation function 801 may be configured to allocate traffic of the bonded data plane session to the output bearers 820 of the data plane session based on policy information from policy function 802 and traffic monitoring information from traffic monitoring function 803. The use of traffic monitoring information of traffic monitoring function 803 to allocate traffic of the bonded data plane session to the output bearers 820 may include providing the traffic monitoring information to the traffic allocation function 801 for use in allocating traffic of the bonded data plane session to the output bearers 820 based on a combination of the policy information of the policy function 802 and based on the traffic monitoring information of the traffic monitoring function 803. The use of traffic monitoring information of traffic monitoring function 803 to allocate traffic of the bonded data plane session to the output bearers 820 may include providing the traffic monitoring information to the policy function 802 for use in modifying the policy information of the policy function 802 and providing the policy information of the policy function 802 to the traffic allocation function 801 for use in allocating traffic of the bonded data plane session to the output bearers 820 based on the policy information of the policy function 802.

The traffic allocation function 801 may utilize various traffic allocation mechanisms to allocate traffic of the bonded data plane session (i.e., received via input bearer 810) to the output bearers 820 of the data plane session. As discussed herein, traffic allocation function 801 may allocate traffic to the output bearers 820 of the bonded data plane session based on policy information and active traffic monitoring. The policy information of policy function 802 may specify percentages of the traffic of the bonded data plane session to be allocated to the respective bearers of the bonded data plane session (e.g., X % for a first bearer and (100−X) % for a second bearer). The policy information of policy function 802 may be dynamically modified based on active traffic monitoring provided by traffic monitoring function 803 (e.g., changing the percentage of traffic allocated to the output bearers 820 by Δ % (e.g., 1%, 5%, 10%, or the like) responsive to detection of one or more conditions (e.g., a threshold traffic rate is detected) based on active traffic monitoring). The traffic allocation function 801, as discussed further below, may be configured to allocate traffic of the bonded data plane session based on an action or set of actions which, as discussed further below, may be based on or defined within the context of a policy or policies of policy function 802, a traffic monitoring technique or techniques of traffic monitoring function 803, or the like, as well as various combinations thereof. The traffic allocation function 801, as discussed further below, may be configured to allocate traffic of the bonded data plane session to the output bearers 820 based on at least one of least one of traffic characteristic information of the traffic to be allocated (e.g., traffic type, traffic source, traffic priority, or the like), link characteristic information associated with the links supporting the output bearers 820 (e.g., link type, link capacity, link priority or preference, or the like), or the like, as well as various combinations thereof. The traffic allocation function 801 may distribute traffic across the output bearers 820 using hashing to boost the access capacity for the user device (e.g., hashing may be used to distribute the traffic according to the percentages specified by the policy being used). The traffic allocation function 801 may use flow hashing on a flow to switch traffic of the flow from a first of the output bearers 820 to a second of the output bearers 820. The traffic allocation function 801 may use packet hashing on packets of one or more flows to distribute traffic of the one or more flows across multiple output bearers 820. The traffic allocation function 801 may allocate traffic to the bearers of the bonded data plane session using various combinations of such techniques, one or more other traffic allocation or distribution techniques, or the like, as well as various combinations thereof. It will be appreciated that the traffic allocation function 801, policy function 802, and traffic monitoring function 803 may interact in various other ways to control allocation of traffic of the bonded data plane session to the output bearers 820 of the bonded data plane session.

The policy function 802 is configured to control policy information which may be used by traffic allocation function 801 to control allocation of traffic of the bonded data plane session (i.e., traffic received via input bearer 810) across the output bearers 820 of the bonded data plane session. The policy function 802 may obtain policy information from various sources of policy information, which may vary depending on the device type of gateway device 800. For example, the policy function 802 may obtain policy information from a policy and rules function (e.g., a PCRF in LTE-based implementations or other similar devices for other implementations), an access network discover/selection function (e.g., an ANDSF in LTE-based implementations or other similar devices for other implementations), a policy server, or the like, as well as various combinations thereof. The policy function 802 may be configured to provide policy information to traffic allocation function 801 for use by traffic allocation function 801 in allocating traffic of the bonded data plane session (i.e., traffic received via input bearer 810) across the output bearers 820 of the bonded data plane session. The policy function 802 may be configured to modify policy information based on traffic monitoring information received from traffic monitoring function 803. The policy function 802 may be configured to provide various other functions for supporting allocation of traffic of the bonded data plane session (i.e., traffic received via input bearer 810) across the output bearers 820 of the bonded data plane session.

The policy function 802 is configured to control policy information which may be used by traffic allocation function 801 to control allocation of traffic of the bonded data plane session (i.e., traffic received via input bearer 810) across the output bearers 820 of the bonded data plane session. The policy information for a bonded data plane session may include one or more policies (e.g., including one or more traffic allocation rules) which may be applied for allocating traffic of the bonded data plane session across the output bearers 820 of the bonded data plane session.

The policy or policies for a bonded data plane session may be configured to specify various actions which may be taken based on various types of information, based on detection of various conditions, or the like, as well as various combinations thereof. The set of actions specific for policies may be different for different policies of policy function 802. The set of actions may include one or more of an action(s) related to allocation of traffic of the bonded data plane session across the bearers of the bonded data plane session (e.g., as provided by traffic allocation function 801), modification of policies (e.g., by policy function 802), or the like, as well as various combinations thereof. The set of actions which may be performed for different traffic monitoring types which may be provided by traffic monitoring function 803 (e.g., using policing, using usage monitoring keys, or the like) are discussed further below within the context of the specific traffic monitoring types which may be provided by traffic monitoring function 803.

The policy or policies for a bonded data plane session may be configured to specify allocation of traffic of the bonded data plane session across the bearers of the bonded data plane session. The policy or policies for a bonded data plane session may be configured to specify allocation of traffic of the bonded data plane session across the bearers of the bonded data plane session based on various types of information, based on detection of various conditions, using various allocation techniques, or the like, as well as various combinations thereof.

The policy for a bonded data plane session may specify allocation of traffic of the bonded data plane session based on traffic allocation percentages (which, as discussed herein, may be based on various considerations, such as access network costs of the access networks supporting the respective bearers, QoS levels supported by the access networks supporting the respective bearers, traffic types, or the like, as well as various combinations thereof). The policy for a bonded data plane session may specify allocation of traffic of the bonded data plane session at least one of for traffic as a whole, based on traffic type, on a per-flow basis, or the like, as well as various combinations thereof.

The policy for a bonded data plane session may specify, for each of the bearers of the bonded data plane session, a respective percentage of the traffic of the bonded data plane session that is to be allocated to that bearer (e.g., 100% to a first bearer (e.g., WiFi) and 0% to a second bearer (e.g., LTE), 95% to a first bearer and 5% to a second bearer, 80% to a first bearer and 20% to a second bearer, 40% each to respective first and second bearers and 20% to a third bearer, or the like).

The policy for allocation of traffic among the bearers of the bonded data plane session may be based on the traffic types of the traffic. The policy for a bonded data plane session may specify, for each traffic type of traffic to be supported via the bonded data plane session (e.g., voice, video, data, or the like), respective portions of each of the traffic types to be allocated to the respective bearers of the bonded data plane session (e.g., 100% of voice on a first bearer and 0% of voice on a second bearers, 0% of video on the first bearer and 100% of video on the second bearer, 80% of data on the first bearer and 20% of data on the second barer, and so forth). The policy for a bonded data plane session may specify, for each traffic type of traffic to be supported via the bonded data plane session (e.g., voice, video, data, or the like), which of the bearers to which the respective traffic type is to be allocated. For example, the policy may indicate that voice traffic is to be directed over a first bearer of the bonded data plane session and other types of traffic are to be directed over a second bearer of the bonded data plane session. For example, the policy may indication that video traffic is to be directed over a first bearer of the bonded data plane session and other types of traffic are to be directed over a second bearer of the bonded data plane session. For example, the policy for allocation of traffic among the bearers of the bonded data plane session may indicate, for each of one or more traffic types, a maximum use of a particular bearer of the bonded data plane session for that traffic type.

The policy for a bonded data plane session may specify, for each traffic flow of the traffic to be supported via the bonded data plane, which of the bearers to which the respective traffic flow is to be allocated.

The policy or policies for a bonded data plane session may specify allocation of traffic of the bonded data plane session to the bearers of the data plane session in various other ways.

The policy or policies for a bonded data plane session may specify allocation of traffic of the bonded data plane session to the bearers of the data plane session based on various combinations of such information, using various combinations of such techniques, or the like, as well as various combinations thereof.

The policy or policies for a bonded data plane session may specify allocation of traffic of the bonded data plane session to the bearers of the data plane session such that different allocations of traffic are made to the bearers under various conditions (e.g., different conditions detected based on active traffic monitoring performed by traffic monitoring function 803, such as detection of various traffic rates or other traffic related parameters associated with transport of the traffic via the bonded data plane session), where the different allocations to be made under different conditions may be specified as multiple different policies to be applied under the different conditions (e.g., each condition has a separate policy associated therewith), as a single policy specifying different allocation rules to be applied under the different conditions, a single policy that is dynamically modified (e.g., in terms of the allocation percentages for the bearers) based on detection of conditions, or the like, as well as various combinations thereof.

The policy or policies for a bonded data plane session may be based on various factors (e.g., access network costs associated with the bearers, provider preferences of a provider(s), traffic balancing goals of a provider(s), QoS considerations, or the like, as well as various combinations thereof). For example, the policy for allocation of traffic among the bearers of a bonded data plane session may be based on the costs of the respective access networks supporting the bearers (e.g., a lower cost access network (bearer) may be preferred over a higher cost access network (bearer), with traffic being allocated to the bearer of the lower cost access network until the capacity of that bearer (or a defined portion of the capacity of that bearer) is consumed at which time traffic is allocated to the bearer of the higher cost access network). For example, the policy for allocation of traffic among the bearers of a bonded data plane session may be based on the QoS levels supported by the respective access networks supporting the bearers (e.g., an access network (bearer) supporting higher QoS may be preferred for carrying traffic requiring higher QoS and an access network (bearer) that supports a lower level of QoS may be preferred for carrying QoS-agnostic traffic). It is noted that various combinations of such considerations and/or various other considerations may be used when specifying the policy for a bonded data plane session.

The policy or policies for a bonded data plane session may be modified based on the active traffic monitoring that is performed by traffic monitoring function 803 (e.g., based on traffic monitoring information provided by the traffic monitoring function 803). The modification of the policy or policies for a bonded data plane session based on the active traffic monitoring that is performed by traffic monitoring function 803 may include one or more of modifying the policy or policies active for the bonded data plane session (e.g., a first set of policies is active for use by traffic allocation function 801 under a first condition or set of conditions, a second set of policies is active for use by traffic allocation function 801 under a second condition or set of conditions, or the like), modifying traffic allocation information of a policy associated with the bonded data plane session (e.g., modifying traffic allocation rules of the policy that are active for the bonded data plane session, modifying the condition(s) and/or action(s) of the policy, or the like), or the like, as well as various combinations thereof. For example, detection of a condition based on active traffic monitoring by traffic monitoring function 803 may including deactivating use of a policy in which 100% of the traffic is allocated to the first bearer and 0% of the traffic is allocated to the second bearer and activating use of a policy in which 90% of the traffic is allocated to the first bearer and 10% of the traffic is allocated to the second bearer. For example, detection of a condition based on active traffic monitoring by traffic monitoring function 803 may include modifying a policy by deactivating use of a traffic allocation rule in which video traffic is allocated to the first bearer and other traffic is allocated to the second bearer and activating use of a policy in which video traffic may be allocated to the first and second bearers and the other traffic is allocated to the second bearer. For example, detection of a condition based on active traffic monitoring by traffic monitoring function 803 may include modifying a policy by changing the traffic allocation percentages of the respective bearers (e.g., changing from use of a 90%/10% traffic split to use of an 85%/15% traffic split). It will be appreciated that various combinations of such policy modification options may be used together. The policy or policies for a bonded data plane session that may be maintained by policy function 802 and used by traffic allocation function 801 for allocating traffic of the bonded data plane session across the bearers of the bonded data plane session may be further understood by way of reference to the description of traffic monitoring function 803 which follows.

The traffic monitoring function 803 is configured to perform traffic monitoring for traffic of the bonded data plane session and to generate traffic monitoring information (e.g., indications of the results of traffic monitoring, indications of conditions detected based on traffic monitoring, or the like) for use in allocating traffic of the bonded data plane session (i.e., traffic received via input bearer 810) across the output bearers 820 of the bonded data plane session. The traffic monitoring function 803 may be configured to provide the traffic monitoring information to the traffic allocation function 801 for use by traffic allocation function 801 to control allocation of traffic of the bonded data plane session (i.e., traffic received via input bearer 810) across the output bearers 820 of the bonded data plane session. The traffic monitoring function 803 may be configured to provide the traffic monitoring information to the policy function 802 for use by the policy function 802 in modifying policy information based on the traffic monitoring information to form thereby modified policy information which may then be used by traffic allocation function 801 to control allocation of traffic of the bonded data plane session (i.e., traffic received via input bearer 810) across the output bearers 820 of the bonded data plane session. The traffic monitoring function 803 may be configured to provide various other functions for supporting allocation of traffic of the bonded data plane session (i.e., traffic received via input bearer 810) across the output bearers 820 of the bonded data plane session.

In at least some embodiments, the active traffic monitoring may include traffic rate monitoring. The traffic rate monitoring may be performed at various granularities (e.g., monitoring the traffic rates on each of the respective bearers of the bonded data plane session, monitoring traffic rates of respective traffic types on each of the respective bearers of the bonded data plane session, or the like, as well as various combinations thereof). The traffic rate monitoring of rates may be performed by calculating the amount of traffic associated with the rate to the calculated (e.g., per bearer, per traffic type per bearer, or the like), which may be performed based on statistics collection related to traffic transported via the bonded data plane session.

In at least some embodiments, the active traffic monitoring may include use of one or more policers.

The use of one or more policers to provide active traffic monitoring within the context of a bonded data plane session may be provided in various ways. The policer(s) used to provide active traffic monitoring for a bonded data plane session may be configured to perform traffic rate policing or other types of policing.

In at least some embodiments, policing is performed using an aggregate policer that performs policing for the bonded data plane session and one or more bearer level policers that perform policing for one or more of the bearers of the bonded data plane session, respectively. In one embodiment, in which the bonded data plane session includes a preferred bearer and a secondary bearer, a policer associated with the preferred bearer is used to control allocation of traffic between the bearers (e.g., when the traffic rate on the preferred bearer, as determined by the policer associated with the preferred bearer, exceeds a threshold then some percentage of traffic is allocated to the secondary bearer) and an aggregate policer associated with the bonded data plane session ensures that the traffic of the bonded data plane session still conforms to the overall aggregate data rate specified for the bonded data plane session.

In at least some embodiments, policing is performed on a per bearer basis for the bonded data plane session using multiple policers for the multiple bearers of the bonded data plane session, respectively. The traffic of the bonded data plane session may be allocated to the bearers serially (e.g., initially sending all traffic over a preferred bearer, directing traffic over a next most preferred bearer when a policer associated with the preferred bearer detects that a traffic rate of the preferred bearer satisfies or exceeds a threshold, and so forth). The traffic of the bonded data plane session may be allocated to the bearers in parallel based on one or more policies or traffic allocation mechanisms, in which case the policers associated with the bearers may operate independently to control the traffic rates of the bearers, respectively. It will be appreciated that various combinations of such traffic allocation and associated policing schemes may be used to police traffic of a bonded data plane session.

In at least some embodiments, policing is performed on a traffic type basis (e.g., one or more policers operating at the bonded data plane session level and/or at the bearer level to provide policing for various traffic types or combinations of traffic types).

In at least some embodiments, policing is performed on a per-flow basis (e.g., one or more policers operating at the bonded data plane session level and/or at the bearer level to provide policing for various traffic flows or combinations of traffic flows). In at least some embodiments, in which policing is performed on a per-flow basis, one or more of the policers used to police the flows within the context of the bonded data plane session may perform policing based on multiple thresholds (e.g., a low threshold and a high threshold). The thresholds may be set to various levels (e.g., 70% for low and 90% for high, 80% for low and 95% for high, or the like). In at least some embodiments, in which multiple thresholds are used by a policer for per-flow policing, color marking techniques may be supported for the traffic being policed (e.g., traffic associated with a rate below the low threshold may be considered to be GREEN, traffic associated with a rate between the low and high thresholds may be considered to be YELLOW, and traffic associated with a rate above the high threshold may be considered to be RED). It will be appreciated that these techniques also may be used where policing is performed at other granularities (e.g., per bearer, per traffic type, or the like).

It will be appreciated that policing may be performed using policers configured to perform policing on various combinations of such granularities (e.g., aggregate bonded data plane session level, per bearer for one or more bearers, per traffic type, per data flow, or the like).

The set of actions to be taken when a threshold of a policer is satisfied or crossed may be based on various policies as discussed herein (e.g., moving traffic of the bonded data plane session from one or more bearers of the bonded data plane session to one or more other bearers of the bonded data plane session).

The set of actions to be taken when a threshold of a policer is satisfied or crossed may be different for different policers (e.g., different policers of different bearers of the bonded data plane session, different policers associated with different traffic types or traffic flows, or the like, as well as various combinations thereof).

The set of actions to be taken when a threshold of a policer is satisfied or crossed may be controlled/initiated in various ways. The set of actions to be taken when a threshold of a policer is satisfied or crossed may be controlled/initiated locally (e.g., on the gateway device providing the maximum fill link capacity). The set of actions to be taken when a threshold of a policer is satisfied or crossed may be controlled/initiated may be initiated via signaling to one or more network-based control elements or other network-based functions (e.g., via signaling by a provide equipment gateway device to a PCRF or other network function, via signaling by a customer premises equipment gateway device to an ANDSF or other network function, or the like) to notify the one or more other elements that a threshold of a policer is satisfied or crossed. The set of actions to be taken when a threshold of a policer is satisfied or crossed may be controlled/initiated in various other ways.

In at least some embodiments, in which three or more bearers are bonded together as part of the bonded data plane session, some or all of the bearers may have respective policers associated therewith. The policers may be configured to monitor various traffic rates. For example, the bearers may be prioritized and utilized serially to support traffic of the bonded data plane session (e.g., allocating traffic to a most preferred bearer until the policer of that bearer detects that a rate threshold is satisfied or crossed at which time traffic of the bonded data plane session is allocated to a next most preferred bearer, allocating traffic to the next most preferred bearer until the policer of that next most preferred bearer detects that a rate threshold is satisfied or crossed at which time traffic of the bonded data plane session is allocated to a next most preferred bearer, and so forth). The policer(s) may utilize various parameters for policing of the bonded data plane session. For example, for a bonded data plane session including an LTE bearer (e.g., PDN connection), a policer may utilize an APN—Aggregate Maximum Bit Rate (APN-AMBR) to perform the policing. It will be appreciated that other parameters may be used for policing when at least one of the bearers is an LTE bearer (e.g., applied for policing of the aggregate bonded data plane session or applied for policing of the LTE bearer of the bonded data plane session). It will be appreciated that other parameters may be used for policing for bearers of other types of access networks.

The use of policer(s) for traffic monitoring for a bonded data plane session may be further understood by way of reference to the following example. In this example, the policy that is applied can be that all the downlink traffic is preferred via Wi-Fi access (e.g., any policy rule with hashing percentage as 100% Wi-Fi and 0% LTE is applied at the start). In this example, traffic monitoring is performed using a policer having two defined traffic rate thresholds (namely, a low threshold and a high threshold). In this example, the delta percentage for the low threshold is set to 5% (which means that each time the low threshold is crossed, the hashing policy is modified by 5%) and the delta for the high threshold is set to 10% (which means that each time the high threshold is crossed, the hashing policy is modified by 10%). As a result, the first time that the traffic rate exceeds the low threshold, the policy is changed to 95% WiFi and 5% LTE. This may be achieved by changing the hashing policy that is used for allocating the traffic to the bearers. In this example, the detection that the traffic rate exceeds the low threshold can be sent from a policer to the control plane in other to change the policy. In this example, based on active traffic monitoring, if the traffic rate still exceeds the low threshold the next time that the traffic rate is measured, then the policy is changed again (in this example, from 95% WiFi and 5% LTE to 90% WiFi and 10% LTE). In this example, such change as be accommodated as long as traffic is distributed 50% Wi-Fi and 50% LTE (which is applicable when both LTE and Wi-Fi have the same bandwidth); however if the access capacities of the WiFi and LTE access networks are unequal then other traffic allocations may be used. In this example, when the traffic rate falls below the lower threshold on the preferred access network and the rate of traffic on other access network aggregated with the preferred access network is less than the lower threshold, then a policy change can be triggered to have all of the traffic allocated to the preferred access network (e.g., in this example, 100% Wi-Fi and 0% LTE).

The policer(s) for traffic monitoring for a bonded data plane session may be implemented in other ways, applied in other ways, or the like, as well as various combinations thereof.

In at least some embodiments, the active traffic monitoring may include use of one or more usage monitoring keys. The usage monitoring key(s) used to provide active traffic monitoring for a bonded data plane session may be configured to perform traffic rate usage monitoring or other types of usage monitoring.

In general, a usage monitoring key may include one or more usage thresholds to be monitored (e.g., based on a service unit defined for the usage monitoring key) and a set of actions to be taken when a usage threshold of the usage monitoring key is satisfied or crossed.

The service unit of a usage monitoring key for the maximum fill link capability may be rate (which may be used in place of or in conjunction with one or more other service units, such as volume, time, or the like).

The one or more usage thresholds to be monitored may include a low usage threshold and a high usage threshold (or two usage thresholds defined in other ways, fewer or more usage thresholds, or the like, as well as various combinations thereof).

The monitoring of the service unit of a usage monitoring key may include monitoring the service unit for collecting statistics at periodic intervals. For example, where the service unit is traffic rate, the traffic rate may be monitored by collecting statistics at period intervals.

The set of actions to be taken when a usage threshold of the usage monitoring key is satisfied or crossed may be based on various policies as discussed further below (e.g., moving traffic of the bonded data plane session from one or more bearers of the bonded data plane session to one or more other bearers of the bonded data plane session).

The set of actions to be taken when a usage threshold of the usage monitoring key is satisfied or crossed may be different for different usage thresholds of the usage monitoring key.

The set of actions to be taken when a usage threshold of the usage monitoring key is satisfied or crossed may be controlled/initiated in various ways. The set of actions to be taken when a usage threshold of the usage monitoring key is satisfied or crossed may be controlled/initiated locally (e.g., on the gateway device providing the maximum fill link capacity). The set of actions to be taken when a usage threshold of the usage monitoring key is satisfied or crossed may be controlled/initiated may be initiated via signaling to one or more network-based control elements or other network-based functions (e.g., via signaling by a provide equipment gateway device to a PCRF or other network function, via signaling by a customer premises equipment gateway device to an ANDSF or other network function, or the like) to notify the one or more other elements that the usage threshold of the usage monitoring key has been satisfied or crossed. The set of actions to be taken when a usage threshold of the usage monitoring key is satisfied or crossed may be controlled/initiated in various other ways.

The use of one or more usage monitoring keys to provide active traffic monitoring within the context of a bonded data plane session may be provided in various ways. In at least some embodiments, active traffic monitoring is performed on a per bearer basis for the bonded data plane session using one or more usage monitoring keys. For example, active traffic monitoring may be performed on a per bearer basis for the bonded data plane session using a single (i.e., the same) usage monitoring key that is applied multiple times for monitoring the respective traffic rates of the respective multiple bearers of the bonded data plane session. For example, active traffic monitoring may be performed on a per bearer basis for the bonded data plane session using multiple usage monitoring keys (which may be defined differently in terms of one or more of the service units used, the usage thresholds used, the actions taken, or the like) that may be applied for monitoring the respective traffic rates of the respective multiple bearers of the bonded data plane. It will be appreciated that combinations of such embodiments may be used where the bonded data plane session includes three or more bearers.

In at least some embodiments, the active traffic monitoring may include a combination of the use of one or more policers and the use of usage monitoring. In at least some embodiments, for example, one or more policers may be used to perform threshold calculations (e.g., calculating one or more thresholds, such as a low threshold and high threshold or various other types of thresholds) and the usage monitoring key can initiate appropriate actions based on one or more thresholds communicated to the usage monitoring key by the one or more policers (e.g., communicated by the one or more policers using threshold triggers). In at least some embodiments, a maximum fill link traffic monitoring function monitors different access type connections of a bonded data plane session (e.g., LTE, Wi-Fi, cable, DSL, satellite, or the like), where the entire bundle of potential access types for the bonded data plane session is represented on the Internet using one IP address (which helps all traffic to be attracted to the anchor point in the core wireless network and which provides a gateway to the Internet). In at least some embodiments, based on the traffic rate, the traffic of the bonded data plane session is sent on the preferred access link (e.g., the preferred access link can be the cheapest access link or may be preferred based on one or more types of traffic characteristics (e.g., low latency, bursty, or the like), bandwidth of the traffic type, or the like, as well as various combinations thereof). It is noted that the traffic characteristics for a type of traffic for uplink and downlink can be different and may be mapped differently to have better performance of the associated application. Various embodiments, include the capability move the traffic from one access network to another access network based on the traffic rate both in uplink and downlink directions. Various embodiments may support a new definition of monitoring key service units and associated actions (e.g., using an extension to PCRF definition or other suitable definitions). Various embodiments may include implementing thresholds (e.g., lower and upper, or using fewer, more, and/or different thresholds) to move traffic (e.g., moving traffic to a secondary bearer when it exceeds a threshold and moving traffic back to the preferred bearer when the aggregate traffic rate falls below the lower threshold). Various embodiments may include the capability to move uplink flows from one access type to another by monitoring the uplink traffic rate. Various embodiments may include the use of triggers (e.g., use of thresholds) to change policy (which also may support getting idle UEs on LTE active before the policy change is applied in the data plane so as to ensure no loss of traffic, such as when a policy associates some percentage (e.g., relative load factor (%)) of flow to be associated with LTE vs WiFi or some other access technology). Various other embodiments are contemplated.

The policies which may be used and actions which may be applied may be further understood with respect to the following example. In this example, in which the bearers of the bonded data plane session include WiFi and LTE bearers anchored at a PGW, assume that the policy is initially set such that 100% of the traffic of the bonded data plane session is allocated to the WiFi bearer and 0% of the traffic of the bonded data plane session is allocated to the LTE bearer. This ensures that the LTE access is idle (i.e., there is no LTE radio resource consumption) until a rate-based condition is detected. The traffic rate on the WiFi bearer is monitored with respect to a threshold and, responsive to a determination that the threshold is satisfied, the policy may be modified to a 95%/5% policy (or other suitable policy, such as 90%/10%, 80%/20%, or the like) in which 95% of the traffic of the bonded data plane session is allocated to the WiFi bearer and 5% of the traffic of the bonded data plane session is allocated to the LTE bearer. In this example, the PGW also may send a downlink data notification (e.g., to setup or activate the LTE bearer for the bonded data session) prior to modifying the policy so that traffic of the bonded data plane session is not allocated to the LTE bearer before the LTE bearer is ready to transport the traffic (thereby preventing loss of traffic).

It is noted that, since traffic flows are typically associated with access, rather than just rate, it may be necessary or desirable to keep the traffic rate below the associated threshold in order to avoid traffic loss. It is further noted that maintaining the traffic rate below the threshold in this manner provides extra room on the associated bearer for carrying so-called “fat” traffic flows (i.e., flows with relatively high bandwidth as compared with other flows).

It will appreciated that, although primarily presented with respect to embodiments in which the policies are configured to effect traffic allocation changes responsive to conditions when the conditions initially occur (e.g., upon the first instance of detecting that a traffic rate satisfies a threshold), in at least some embodiments the policies may be configured to effect traffic allocation changes responsive to sustained conditions (e.g., the traffic rate is over the defined threshold for 3 consecutive measurements, the traffic rate is over the defined threshold for 3 consecutive measurements, the traffic rate is over the defined threshold for 30 seconds, the traffic rate is over the defined threshold for 5 minutes, or the like, as well as various combinations thereof). This may be used in various cases in which frequent traffic reallocations may not be the best option, may be undesirable, or the like. It will be appreciated that various combinations of such embodiments may be used for a policy (e.g., for a policy having a low traffic rate threshold of 70% and a high traffic rate threshold of 90%, if the traffic rate is above 70% for three consecutive measurements then the policy is applied such that some traffic is allocated to a secondary bearer and then if the traffic rate is above 90% for even a single measurement then the policy is applied such that traffic is allocated to the secondary bearer immediately or nearly immediately).

It will be appreciated that, although primarily presented herein with respect to policies which specify allocation of traffic of a bonded data plane session in a particular direction (e.g., from a preferred bearer to a less preferred bearer) responsive to a condition (e.g., traffic rate on the preferred bearer exceeding a defined threshold), policies of the bonded data plane session also may specify allocation of traffic of the bonded data plane session in other directions responsive to various condition (e.g., returning traffic from a less preferred bearer to a preferred bearer responsive to detecting that the condition which initially caused the reallocation of the traffic from the preferred bearer to the non-preferred bearer is no longer present such that the traffic may be moved back, or the like).

It will be appreciated that, although primarily presented herein with respect to embodiments in which the maximum fill link capability for a bonded data plane session is applied at a network gateway device (e.g., PGW, PGW/SGW, or other suitable gateway device) for traffic to be transmitted in the downstream direction, the maximum fill link capability also may be applied at a customer device (e.g., UE) for traffic to be transmitted in the upstream direction. In at least some embodiments, in which flow-based allocation/policing is used, one or more flow based policers may use deep packet inspection for flow identification and then any flow to be moved from a first bearer to a second bearer can be moved based on network based IP flow mobility (NB-IFOM), such as by sending an update bearer request (e.g., with an identification of the flow to be moved, such as with a TFT that includes a 5-tuple of other suitable identifier of the flow) on the second bearer to which the flow is to be moved.

The maximum fill link capability may be used in various contexts, for various purposes, or the like, as well as various combinations thereof. In various embodiments, a maximum fill link capability may be used by a system operator in order to direct certain types of traffic onto one access type (one of the bearers of the bonded data plane session) such that the other access type (the other of the bearers of the bonded data plane session) or a portion thereof may be kept free or substantially free so that it is available for handling a particular traffic type(s). For example, a cellular bearer of the bonded data plane session may be used for traffic other than video and a WiFi bearer of the bonded data plane session may be kept free, or as free as possible, so that the WiFi bearer is available for handling any video traffic that may need to be transported via the bonded data plane session. In various embodiments, when the bearers of the bonded data plane session include a non-leased bearer and a leased bearer (e.g., the system operator leases the bearer from another operator), the maximum fill link capability may be used by the system operator in order to preferentially use the non-leased bearer of the bonded data plane session (e.g., to its capacity, within a threshold of its capacity, or the like)) before using the leased bearer of the bonded data plane session. In various embodiments, when the bearers of the bonded data plane session have different costs to the service provider, the maximum fill link capability may be used by the system operator in order to preferentially use the lower cost bearer of the bonded data plane session (e.g., to its capacity, within a threshold of its capacity, or the like)) before using the higher cost bearer of the bonded data plane session. In various embodiments, the maximum fill link capability may be used by the system operator in order to use a first network access type for uplink traffic (e.g., by allocating the traffic to the bearer of the first network access type) and to use a second network access type for downlink traffic (e.g., by allocating the traffic to the bearer of the second network access type). Various other embodiments and use cases are contemplated.

FIG. 9 depicts an exemplary embodiment of a method for providing a maximum fill link capability at a gateway device. The gateway device is configured to support a user device data plane session having multiple bearers associated with multiple different access networks. The gateway device may a network gateway device or a customer gateway device. It will be appreciated that although primarily presented herein as being performed serially, at least a portion of the steps of method 900 may be performed contemporaneously or in a different order than as presented in FIG. 9. At step 901, method 900 begins. At step 910, the gateway device receives user device traffic of the user device data plane session. At step 920, the gateway device performs traffic monitoring for the user device traffic of the user device data plane session. At step 930, the gateway device determines, based on policy information associated with the user device data plane session and based on the traffic monitoring performed for the user device traffic of the user device data plane session, an allocation of the user device traffic of the user device data plane session to the multiple bearers of the user device data plane session. At step 999, method 900 ends.

In at least some embodiments, a paging mechanism may be provided to reduce or prevent loss of data when traffic is switched to a bearer associated with a wireless user device that is idle. For example, it will be appreciated that various embodiments of the maximum fill link capability may result in traffic being directed onto an LTE bearer. If the LTE bearer is in idle mode when the traffic is switched onto the LTE bearer, traffic may be dropped. In at least some embodiments, in order to reduce or prevent loss of traffic due to switching of traffic onto an idle LTE bearer, after making a determination to switch the traffic onto the LTE bearer but before actually switching the traffic onto the LTE bearer, a process for switching the UE from idle mode to active mode may be initiated. For example, this process may be initiated by the traffic monitoring component based on detection of a condition that results in switching of the traffic to the LTE bearer. The process may include triggering the control plane to page the UE to make the UE active. The UE may be paged with the TEID of the eNodeB learned from the MME programmed in the data plane.

In at least some embodiments, if the gateway is operating as a combination PGW/SGW function, then the control plane can trigger the paging and, based on receipt of an associated Modify Bearer request and after programming the TEID of the eNodeB, the UE will be in connected mode such that the gateway can switch the traffic to the LTE bearer (e.g., switching a policy, applying a policy, or the like) and the traffic will flow seamlessly to the UE.

In at least some embodiments, if the gateway is operating as a PGW function only, then (1) the control plane can send end of marker (EOM) packets on the LTE link which will trigger paging by the SGW, (2) when the Modify Bearer request is sent from MME, the MME may include the ULI information which will result in receiving the Modify Bearer request by the PGW at which point the PGW switches the traffic onto the LTE bearer (e.g., switching a policy, applying a policy, or the like), and (3) by this time the SGW has programmed the TEID of the eNodeB and the UE is in connected mode and ready to receive the traffic such that the traffic will flow seamlessly to the UE.

In at least some embodiments, switching of the UE from idle mode to active mode may be performed by extending one or more indication flags in a downlink data notification message (e.g., paging due to EOM packets or by configuration on the SGW for a given APN) and, based on receipt of this message, the MME sends the Modify Bearer request up to the PGW such that the PGW switches the traffic onto the LTE bearer (e.g., switching a policy, applying a policy, or the like).

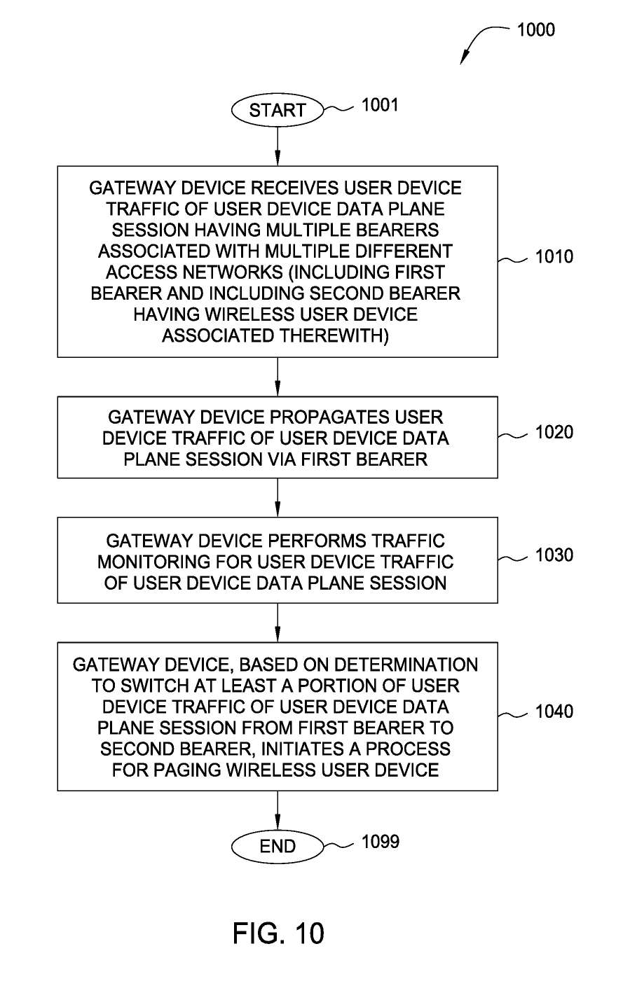

It will be appreciated that, although primarily described with respect to embodiments of the paging mechanism in which the bearer associated with the wireless user device is LTE, the paging mechanism may be applied, to reduce or prevent loss of data when traffic is switched to a bearer associated with a wireless user device that is idle, within the context of other types of wireless bearers. Accordingly, a more general embodiment of the paging mechanism is depicted and described with respect to FIG. 10.

FIG. 10 depicts an exemplary embodiment of a method for paging a wireless user device within the context of providing a maximum fill link capability at a gateway device. It will be appreciated that although primarily presented herein as being performed serially, at least a portion of the steps of method 1000 may be performed contemporaneously or in a different order than as presented in FIG. 10. At step 1001, method 1000 begins. At step 1010, the gateway device receives user device traffic of a user device data plane session having multiple bearers associated with multiple different access networks. The multiple bearers include a first bearer and a second bearer. The first bearer may be a wireline bearer or a wireless bearer. The second bearer has a wireless user device associated therewith. The second bearer may be a wireless bearer supporting an idle mode capability in which the associated wireless user device may enter an idle mode. For example, the second bearer may be an LTE bearer or other suitable type of bearer. At step 1020, the gateway device propagates the user device traffic of the user device data plane session via the first bearer. At step 1030, the gateway device performs traffic monitoring for the user device traffic of the user device data plane session. At step 1040, the gateway device, based on a determination to switch at least a portion of the user device traffic of the user device data plane session from the first bearer to the second bearer, initiates a process for paging the wireless user device. At step 1099, method 1000 ends.

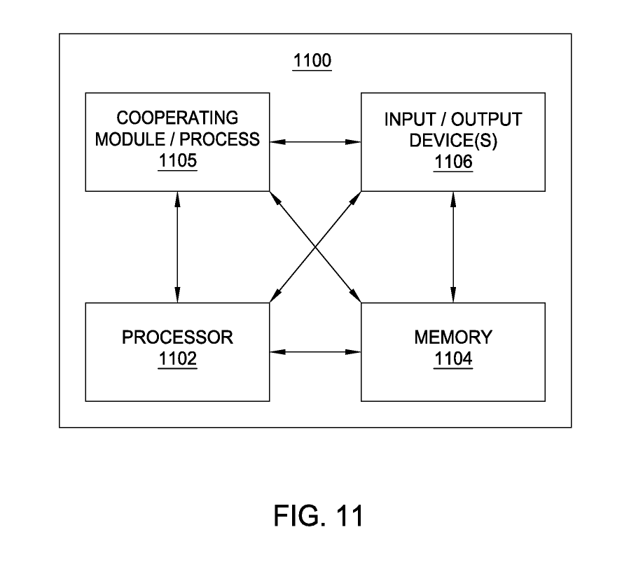

FIG. 11 depicts a high-level block diagram of a computing device, such as a processor in a telecom network element, suitable for use in performing functions described herein such as those associated with the various elements described herein with respect to the figures.

As depicted in FIG. 11, computing device 1100 includes a processor element 1102 (e.g., a central processing unit (CPU) and/or other suitable processor(s)), a memory 1104 (e.g., random access memory (RAM), read only memory (ROM), and the like), cooperating module/process 1105, and various input/output devices 1106 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

In the case of a routing or switching device such as PGW/SGW 150, RG/CPE 110, BNG 130, and the like, the cooperating module/process 1105 may implement various switching devices, routing devices, interface devices, and so on, as known to those skilled in the art. Thus, the computing device 1100 may be implemented within the context of such a routing or switching device (or within the context of one or more modules or sub-elements of such a device), further functions appropriate to that routing or switching device are also contemplated and these further functions may be in communication with or otherwise associated with one or more of the processor 1102, memory 1104, and input/output devices 1106 of the computing device 1100 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 1105 can be loaded into memory 1104 and executed by processor 1102 to implement the functions as discussed herein. Thus, cooperating process 1105 (including associated data structures) can be stored on a computer readable storage medium, e.g., RAM memory, magnetic or optical drive or diskette, and the like.

It will be appreciated that computing device 1100 depicted in FIG. 11 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the various methods may be stored in tangible and non-transitory computer readable medium such as fixed or removable media or memory, and/or stored within a memory within a computing device operating according to the instructions.

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, at a gateway device configured to support a user device data plane session having multiple bearers associated with multiple different access networks, user device traffic of the user device data plane session;
perform traffic monitoring for the user device traffic of the user device data plane session; and
determine, based on policy information associated with the user device data plane session and based on the traffic monitoring for the user device traffic of the user device data plane session, an allocation of the user device traffic of the user device data plane session to the multiple bearers of the user device data plane session.

2. The apparatus of claim 1, wherein the traffic monitoring is performed using a single policer for the user device data plane session.

3. The apparatus of claim 1, wherein the traffic monitoring is performed on a per-bearer basis for the multiple bearers of the user device data plane session using multiple policers for the multiple bearers of the user device data plane session.

4. The apparatus of claim 1, wherein the traffic monitoring is performed using a first policer for the user device data plane session and a second policer for one of the multiple bearers of the user device data plane session.

5. The apparatus of claim 1, wherein the traffic monitoring is performed using a usage monitoring key.

6. The apparatus of claim 5, wherein the usage monitoring key is configured to perform traffic rate usage monitoring.

7. The apparatus of claim 1, wherein the traffic monitoring is performed based on a threshold.

8. The apparatus of claim 7, wherein the processor is configured to:
based on a determination that the threshold has been satisfied, modify the allocation of the user device traffic of the user device data plane session to the multiple bearers of the user device data plane session.

9. The apparatus of claim 7, wherein the processor is configured to:
based on a determination that the threshold has been satisfied, modify the policy information associated with the user device data plane session.

10. The apparatus of claim 9, wherein, to modify the policy information associated with the user device data plane session, the processor is configured to:
switch from using a first policy specifying a first allocation of the user device traffic of the user device data plane session to the multiple bearers of the user device data plane session to using a second policy specifying a second allocation of the user device traffic of the user device data plane session to the multiple bearers of the user device data plane session.

11. The apparatus of claim 9, wherein, to modify the policy information associated with the user device data plane session, the processor is configured to:
modify an allocation percentage associated with one of the multiple bearers of the user device data plane session.

12. The apparatus of claim 1, wherein the processor is configured to:
modify the allocation of the user device traffic of the user device data plane session to the multiple bearers of the user device data plane session based on at least one of traffic characteristic information or link characteristic information.

13. The apparatus of claim 1, wherein the user device traffic of the user device data plane session comprises a flow associated with a first bearer of the multiple bearers, wherein the processor is configured to:
modify the allocation of the user device traffic of the user device data plane session to the multiple bearers of the user device data plane session using flow hashing on the flow for switching the flow from the first bearer of the multiple bearers to a second bearer of the multiple bearers.

14. The apparatus of claim 1, wherein the user device traffic of the user device data plane session comprises a flow, wherein the processor is configured to: modify the allocation of the user device traffic of the user device data plane session to the multiple bearers of the user device data plane session using packet hashing for distributing packets of the flow across two or more of the multiple bearers.

15. The apparatus of claim 1, wherein the gateway device comprises a provider equipment (PE) gateway device configured to allocate downstream user device traffic among the multiple bearers.

16. The apparatus of claim 15, wherein the user device is associated with multiple different IP addresses for each of the multiple bearers and is associated with a single advertised public IP address for traffic received by the PE gateway device.

17. The apparatus of claim 15, wherein the policies are received from a Policy and Charging Rules Function (PCRF).

18. The apparatus of claim 1, wherein the gateway device comprises a Customer Premises Equipment (CPE) gateway device configured to allocate upstream user device traffic among the bearers.

19. The apparatus of claim 18, wherein the CPE gateway device is associated with a single IP address for each of the multiple bearers.

20. The apparatus of claim 18, wherein the policies are received from an Access Network Discovery and Selection Function (ANDSF).

21. The apparatus of claim 18, wherein the CPE gateway device comprises a residential gateway (RG), wherein a first bearer of the multiple bearers is associated with a digital subscriber line (DSL) access network and a second bearer is associated with a cellular access network.

22. The apparatus of claim 1, wherein a first bearer of the multiple bearers is associated with a wireline access network and a second bearer of the multiple bearers is associated with a wireless access network.

23. The apparatus of claim 1, wherein a first bearer of the multiple bearers is associated with a first type of wireless access and a second bearer of the multiple bearers is associated with a second type of wireless access.

24. The apparatus of claim 23, wherein the first type of wireless access comprises cellular access and the second type of wireless access comprises satellite.

25. A non-transitory computer-readable storage medium storing instructions which, when executed by a computer, cause the computer to perform a method, the method comprising:
receiving, at a gateway device configured to support a user device data plane session having multiple bearers associated with multiple different access networks, user device traffic of the user device data plane session;
performing traffic monitoring for the user device traffic of the user device data plane session; and
determining, based on policy information associated with the user device data plane session and based on the traffic monitoring for the user device traffic of the user device data plane session, an allocation of the user device traffic of the user device data plane session to the multiple bearers of the user device data plane session.

26. A method, comprising:
receiving, at a gateway device configured to support a user device data plane session having multiple bearers associated with multiple different access networks, user device traffic of the user device data plane session;
performing traffic monitoring for the user device traffic of the user device data plane session; and
determining, based on policy information associated with the user device data plane session and based on the traffic monitoring for the user device traffic of the user device data plane session, an allocation of the user device traffic of the user device data plane session to the multiple bearers of the user device data plane session.

27. An apparatus, comprising:
a processor and a memory communicatively connected to the processor, the processor configured to:
receive, at a gateway device configured to support a user device data plane session having multiple bearers associated with multiple different access networks, user device traffic of the user device data plane session, wherein the multiple bearers comprise a first bearer and a second bearer, the second bearer having a wireless user device associated therewith;
propagate the user device traffic of the user device data plane session via the first bearer;
perform traffic monitoring for the user device traffic of the user device data plane session; and
based on a determination to switch at least a portion of the user device traffic of the user device data plane session from the first bearer to the second bearer, initiate a process for paging the wireless user device.
